SEQUENCE LISTING (102 sequences)

SEQ ID NO: 1 - DNA, 58 bp, Artificial sequence
  chemically synthesized
agcctacgtacgtggttacctgtacgtttgggaccaatgcattgcaatgctgatgatg

SEQ ID NO: 2 - DNA, 37 bp, Artificial sequence
  chemically synthesized
cctacgtacgtggttacctgtacgtttgggaccaatg

SEQ ID NO: 3 - DNA, 37 bp, Artificial sequence
  chemically synthesized
ctacgtacgtggttacctgtacgtttgggaccaatgc

SEQ ID NO: 4 - DNA, 37 bp, Artificial sequence
  chemically synthesized
tacgtacgtggttacctgtacgtttgggaccaatgca

SEQ ID NO: 5 - DNA, 36 bp, Artificial sequence
  chemically synthesized
cgtacgtggttacctgtacgtttgggaccaatgcat

SEQ ID NO: 6 - DNA, 36 bp, Artificial sequence
  chemically synthesized
gtacgtggttacctgtacgtttgggaccaatgcatt

SEQ ID NO: 7 - DNA, 36 bp, Artificial sequence
  chemically synthesized
tacgtggttacctgtacgtttgggaccaatgcattg

SEQ ID NO: 8 - DNA, 36 bp, Artificial sequence
  chemically synthesized
acgtggttacctgtacgtttgggaccaatgcattgc

SEQ ID NO: 9 - DNA, 36 bp, Artificial sequence
  chemically synthesized
cgtggttacctgtacgtttgggaccaatgcattgca

SEQ ID NO: 10 - DNA, 36 bp, Artificial sequence
  chemically synthesized
gtggttacctgtacgtttgggaccaatgcattgcaa

SEQ ID NO: 11 - DNA, 32 bp, Artificial sequence
  chemically synthesized
acgtggttacctgtacgtttgggaccaatgca

SEQ ID NO: 12 - DNA, 32 bp, Artificial sequence
  chemically synthesized
acgtggttacttgtacgtttgggaccaatgca

SEQ ID NO: 13 - DNA, 32 bp, Artificial sequence
  chemically synthesized
acgtggttacctgtatgtttgggaccaatgca

SEQ ID NO: 14 - DNA, 32 bp, Artificial sequence
  chemically synthesized
acatggttacctgtacgtttgggaccaatgca

SEQ ID NO: 15 - DNA, 32 bp, Artificial sequence
  chemically synthesized
acatggttacctgtatgtttgggacacgtggt

SEQ ID NO: 16 - DNA, 32 bp, Artificial sequence
  chemically synthesized
acgtggttacctgtacgtttgggactaatgca

SEQ ID NO: 17 - DNA, 32 bp, Artificial sequence
  chemically synthesized
acgtggttacctgtatgtttgggactaatgca

SEQ ID NO: 18 - DNA, 36 bp, Artificial sequence
  chemically synthesized
acgtacgtggttacctgtacgtttgggaccaatgca

SEQ ID NO: 19 - DNA, 36 bp, Artificial sequence; identical to SEQ ID NO: 5
  chemically synthesized

SEQ ID NO: 20 - DNA, 36 bp, Artificial sequence; identical to SEQ ID NO: 6
  chemically synthesized

SEQ ID NO: 21 - DNA, 36 bp, Artificial sequence; identical to SEQ ID NO: 7
  chemically synthesized

SEQ ID NO: 22 - DNA, 36 bp, Artificial sequence; identical to SEQ ID NO: 10
  chemically synthesized

SEQ ID NO: 23 - DNA, 37 bp, Artificial sequence
  chemically synthesized
tggttacctgtacgtttgggaccaatgcattgcaact

SEQ ID NO: 24 - DNA, 37 bp, Artificial sequence
  chemically synthesized
gttacctgtacgtttgggaccaatgcattgcaactga

SEQ ID NO: 25 - DNA, 37 bp, Artificial sequence
  chemically synthesized
tacctgtacgtttgggaccaatgcattgcaactgatc

SEQ ID NO: 26 - DNA, 38 bp, Artificial sequence
  chemically synthesized
acgtttgggaccaatgcattgcaactgatccctgatcg

SEQ ID NO: 27 - DNA, 35 bp, Artificial sequence
  chemically synthesized
ttgggaccaatgcattgcaactgatccctgatcgt

SEQ ID NO: 28 - DNA, 34 bp, Artificial sequence
  chemically synthesized
gggaccaatgcattgcaactgatccctgatcgta

SEQ ID NO: 29 - DNA, 33 bp, Artificial sequence
  chemically synthesized
gaccaatgcattgcaactgatccctgatcgtag

SEQ ID NO: 30 - DNA, 18 bp, Artificial sequence
  chemically synthesized
tacctgtacgtttgggac

SEQ ID NO: 31 - DNA, 18 bp, Artificial sequence
  chemically synthesized
tacctgtacgtttgggat

SEQ ID NO: 32 - DNA, 18 bp, Artificial sequence
  chemically synthesized
tacctgtacgtttaggac

SEQ ID NO: 33 - DNA, 18 bp, Artificial sequence
  chemically synthesized
tatctgtacgtttgggac

SEQ ID NO: 34 - DNA, 18 bp, Artificial sequence
  chemically synthesized
tacctgtacgtttaggat

SEQ ID NO: 35 - DNA, 18 bp, Artificial sequence
  chemically synthesized
gtttgggaccaatgcatt

SEQ ID NO: 36 - DNA, 18 bp, Artificial sequence
  chemically synthesized
gtttgggatcaatgcatt

SEQ ID NO: 37 - DNA, 18 bp, Artificial sequence
  chemically synthesized
gtctgggaccaatacatt

SEQ ID NO: 38 - DNA, 18 bp, Artificial sequence
  chemically synthesized
gtttaggaccaatacatt

SEQ ID NO: 39 - DNA, 18 bp, Artificial sequence
  chemically synthesized
gtttaggatcaatgcatt

SEQ ID NO: 40 - DNA, 18 bp, Artificial sequence
  chemically synthesized
gtttaggatcaatgcaat

SEQ ID NO: 41 - DNA, 18 bp, Artificial sequence
  chemically synthesized
caatgcattgcaactgat

SEQ ID NO: 42 - DNA, 18 bp, Artificial sequence
  chemically synthesized
caatgcattacaactgat

SEQ ID NO: 43 - DNA, 18 bp, Artificial sequence
  chemically synthesized
caatacattgcaactgat

SEQ ID NO: 44 - DNA, 18 bp, Artificial sequence
  chemically synthesized
caatgcattgcaattgat

SEQ ID NO: 45 - DNA, 48 bp, Artificial sequence
  chemically synthesized
gtacgtggttacctgtacgtttgggaccaatgcattgcaactgatccc

SEQ ID NO: 46 - DNA, 50 bp, Artificial sequence
  chemically synthesized
gtacgtggttacctgtacgtttgggaccaatgcattgcaactgatccctg

SEQ ID NO: 47 - DNA, 51 bp, Artificial sequence
  chemically synthesized
gtacgtggttacctgtacgtttgggaccaatgcattgcaactgatccctga

SEQ ID NO: 48 - DNA, 51 bp, Artificial sequence
  chemically synthesized
cgtggttacctgtacgtttgggaccaatgcattgcaactgatccctgatcg

SEQ ID NO: 49 - DNA, 51 bp, Artificial sequence
  chemically synthesized
ggttacctgtacgtttgggaccaatgcattgcaactgatccctgatcgagt

SEQ ID NO: 50 - DNA, 51 bp, Artificial sequence
  chemically synthesized
tacctgtacgtttgggaccaatgcattgcaactgatccctgatcgtagtac

SEQ ID NO: 51 - DNA, 51 bp, Artificial sequence
  chemically synthesized
tacgtttgggaccaatgcattgcaactgatccctgatcgtagtacctgtac

SEQ ID NO: 52 - DNA, 50 bp, Artificial sequence
  chemically synthesized
gtttgggaccaatgcattgcaactgatccctgatcgtagtacctgtacgt

SEQ ID NO: 53 - DNA, 50 bp, Artificial sequence
  chemically synthesized
gggaccaatgcattgcaactgatccctgatcgtagtacctgtacgtgacc

SEQ ID NO: 54 - DNA, 50 bp, Artificial sequence
  chemically synthesized
accaatgcattgcaactgatccctgatcgtagtacctgtacgtgaccaat

SEQ ID NO: 55 - DNA, 50 bp, Artificial sequence
  chemically synthesized
aatgcattgcaactgatccctgatcgtagtacctgtacgtgaccaatgca

SEQ ID NO: 56 - DNA, 50 bp, Artificial sequence
  chemically synthesized
gcattgcaactgatccctgatcgtagtacctgtacgtgaccaatgcatat

SEQ ID NO: 57 - DNA, 50 bp, Artificial sequence
  chemically synthesized
ttgcaactgatccctgatcgtagtacctgtacgtgaccaatgcatatgca

SEQ ID NO: 58 - DNA, 50 bp, Artificial sequence
  chemically synthesized
acgtggttacctgtacgtttgggaccaatgcattgcaactgatccctgat

SEQ ID NO: 59 - DNA, 51 bp, Artificial sequence
  chemically synthesized
ctgtacgtttgggaccaatgcattgcaactgatccctgatcgtagtacctg

SEQ ID NO: 60 - DNA, 50 bp, Artificial sequence
  chemically synthesized
caactgatccctgatcgtagtacctgtacgtgaccaatgcatatgcaggc

SEQ ID NO: 61 - DNA, 36 bp, Artificial sequence
  chemically synthesized
tacctgtacgtttgggaccaatgcattgcaactgat

SEQ ID NO: 62 - DNA, 36 bp, Artificial sequence
  chemically synthesized
tacctgtacgtttgggaccaatgcattacaactgat

SEQ ID NO: 63 - DNA, 36 bp, Artificial sequence
  chemically synthesized
tacctgtacgtttgggaccaatgcattgcaattgat

SEQ ID NO: 64 - DNA, 36 bp, Artificial sequence
  chemically synthesized
tacctgtacgtttgggatcaatgcattgcaactgat

SEQ ID NO: 65 - DNA, 36 bp, Artificial sequence
  chemically synthesized
tacctgtacgtttgggatcaatgcattacaactgat

SEQ ID NO: 66 - DNA, 36 bp, Artificial sequence
  chemically synthesized
tacctgtacgtttgggatcaatgcattgcaattgat

SEQ ID NO: 67 - DNA, 36 bp, Artificial sequence
  chemically synthesized
tacctgtacgtttaggaccaatacattgcaactgat

SEQ ID NO: 68 - DNA, 36 bp, Artificial sequence
  chemically synthesized
tatctgtacgtttgggaccaatgcattgcaactgat

SEQ ID NO: 69 - DNA, 36 bp, Artificial sequence
  chemically synthesized
tatctgtacgtttgggaccaatgcattacaactgat

SEQ ID NO: 70 - DNA, 36 bp, Artificial sequence
  chemically synthesized
tatctgtacgtttgggaccaatgcattgcaattgat

SEQ ID NO: 71 - DNA, 36 bp, Artificial sequence
  chemically synthesized
tacctgtacgtttaggatcaatgcattgcaactgat

SEQ ID NO: 72 - DNA, 36 bp, Artificial sequence
  chemically synthesized
tacctgtacgtttaggatcaatgcattacaactgat

SEQ ID NO: 73 - DNA, 36 bp, Artificial sequence
  chemically synthesized
tacctgtacgtttaggatcaatgcattgcaattgat

SEQ ID NO: 74 - DNA, 27 bp, Artificial sequence
  chemically synthesized
gctcttgagatctccggttgggattcc

SEQ ID NO: 75 - DNA, 23 bp, Artificial sequence
  chemically synthesized
ggtagcggcgggagaagtcgtcg

SEQ ID NO: 76 - DNA, 27 bp, Artificial sequence
  chemically synthesized
ggtgatgcaagaagtttctaggaaagg

SEQ ID NO: 77 - DNA, 23 bp, Artificial sequence
  chemically synthesized
cggctctcattaggaagatcacg

SEQ ID NO: 78 - DNA, 24 bp, Artificial sequence
  chemically synthesized
ccccggcctaagcgggactaggag

SEQ ID NO: 79 - DNA, 25 bp, Artificial sequence
  chemically synthesized
cagagcacctttgcaatttataggg

SEQ ID NO: 80 - DNA, 25 bp, Artificial sequence
  chemically synthesized
gccacctgctgtgggtgccggagac

SEQ ID NO: 81 - DNA, 27 bp, Artificial sequence
  chemically synthesized
ctctagggcctttgttttctgctactg

SEQ ID NO: 82 - DNA, 21 bp, Artificial sequence
  chemically synthesized
aaagaacggagggagggatcg

SEQ ID NO: 83 - DNA, 24 bp, Artificial sequence
  chemically synthesized
acccaacaccacgtcctaacacct

SEQ ID NO: 84 - DNA, 23 bp, Artificial sequence
  chemically synthesized
ctttaactcaagactgcctcccg

SEQ ID NO: 85 - DNA, 23 bp, Artificial sequence
  chemically synthesized
tcgttgagagggtaggggaagac

SEQ ID NO: 86 - DNA, 24 bp, Artificial sequence
  chemically synthesized
tacgggtccaagccagggttctcc

SEQ ID NO: 87 - DNA, 24 bp, Artificial sequence
  chemically synthesized
gccccagagactcggagaagcaga

SEQ ID NO: 88 - DNA, 22 bp, Artificial sequence
  chemically synthesized
cagcgccctcagttgtcctccg

SEQ ID NO: 89 - DNA, 23 bp, Artificial sequence
  chemically synthesized
tcaccatcgaagtccgtgtagac

SEQ ID NO: 90 - DNA, 23 bp, Artificial sequence
  chemically synthesized
tcggcattctgcaacaggtaagg

SEQ ID NO: 91 - DNA, 23 bp, Artificial sequence
  chemically synthesized
ccttctccttctaccgacacttc

SEQ ID NO: 92 - DNA, 26 bp, Artificial sequence
  chemically synthesized
gcgttaaggaagttgcccaaaatgag

SEQ ID NO: 93 - DNA, 26 bp, Artificial sequence
  chemically synthesized
ccaagaatcagatatggcacaacatc

SEQ ID NO: 94 - DNA, 25 bp, Artificial sequence
  chemically synthesized
cgcccaggtcccctcggaacatgcc

SEQ ID NO: 95 - DNA, 26 bp, Artificial sequence
  chemically synthesized
gccttagccctggattccaaggcatt

SEQ ID NO: 96 - DNA, 24 bp, Artificial sequence
  chemically synthesized
ggtaggggatgcgtggcctctaac

SEQ ID NO: 97 - DNA, 28 bp, Artificial sequence
  chemically synthesized
gtccaactcataagggaaatgctttctg

SEQ ID NO: 98 - DNA, 27 bp, Artificial sequence
  chemically synthesized
ggtaaatataggtatattggtgccctg

SEQ ID NO: 99 - DNA, 27 bp, Artificial sequence
  chemically synthesized
gagggtcttctgcttgctggctgtagc

SEQ ID NO: 100 - DNA, 30 bp, Artificial sequence
  chemically synthesized
gtctcagagaggagccttagccctggactc

SEQ ID NO: 101 - DNA, 27 bp, Artificial sequence
  chemically synthesized
cccagatgggtcctgtcccaggtgcag

SEQ ID NO: 102 - DNA, 23 bp, Artificial sequence
  chemically synthesized
aaggtgtccagtgtgaggtgcag

(19) United States
(12) Patent Application Publication
(10) Pub. No.: US 2016/0034638 A1
(43) Pub. Date: Feb. 4, 2016

(54) System and Method for Detecting Population Variation from Nucleic Acid Sequencing Data

(71) Applicant: UNIVERSITY OF ROCHESTER, Rochester, NY (US)

(72) Inventors: Janice M. Spence, Webster, NY (US); John P. Spence, Webster, NY (US); Richard W. Burack, Rochester, NY (US)

(73) Assignee: University of Rochester, Rochester, NY (US)

(21) Appl. No.: 14/776,632

(22) PCT Filed: Mar. 14, 2014
(86) PCT No.: PCT/US14/28557

§ 371 Date: Sep. 14, 2015

Related U.S. Application Data
(60) Provisional application No. 61/785,594, filed on Mar. 14, 2013.

(51) Int. Cl. G06F 19/22

(52) U.S. Cl. CPC G06F 19/22

(57) ABSTRACT

The present invention relates to a method of identifying genetic variants within a population of sequences. The method includes the steps of aligning a set of sequence data reads to reference sequences, dividing reference sequences into multiple tracks of overlapping regions of analysis (ROAs), partitioning each read into a ROA, identifying a plurality of sequence patterns in the reads, setting a sequence pattern frequency threshold value, eliminating any sequence pattern that has a value below the frequency threshold value forming a plurality of dictionaries from the sequence patterns having a value above the frequency threshold value, and cross-validating sequence patterns via partial sequence assembly. The method may optionally include amending the reference sequences used in iterative re-alignment of sequence data.

### CROSS-REFERENCE TO RELATED APPLICATIONS

This application claims priority to U.S. Patent Application Ser. No. 61/785,594 filed Mar. 14, 2013, the entire disclosure of which is incorporated by reference herein in its entirety.

### BACKGROUND OF THE INVENTION

Many biological fields that utilize population—based studies are discovering the enormous advances made possible through the use of next generation DNA sequencing techniques. Also known as massively parallel sequencing, these techniques allow simultaneous DNA sequencing of thousands of individuals within a given population, resulting in the ability to categorize genetic variation within these groups in a precise and efficient manner.

A new approach to the study of microbial communities relies on the use of the 16S ribosomal gene sequence variations to identify the microbial species present in the population. This has allowed for novel environmental studies, often referred to as various microbiomes, which have illustrated the diversity of various ecological niches to include many microbes that cannot be cultivated under laboratory conditions and were therefore missed by previous approaches. These microbiome studies are being expanded to include identification of viral populations (virobiome) in soil and aquatic environments. This genetic approach to studies of microbial communities has spread into the medical field, where the recognition of the protective role of normal flora, the microbes that normally live in and on the human host, has led to a large multi-centered study to identify the various microbial populations that live in various niches of the human body in sickness and in health. These genetic approaches are also being expanded to explore the viral communities that co-exist within these various sites. The genome-wide association studies (GWAS) is the attempt to link genomic haplotypes to specific disease susceptibilities. A spin-off of these types of studies involves the whole-scale screening of populations to determine the relative frequencies of these haplotypes within certain groups. The ability to pool samples while maintaining accuracy results in cost efficiencies. Unfortunately, current methods to create these efficiencies have been unable to maintain the desired accuracy.

For example, next generation sequencing platforms result in highly noisy data, and consequently each such platform relies on a large number of replicates representing each part of the sample nucleic acid to allow interpretation of the data. For example, all of such sequencers rely on generating an identical signal from the DNA cluster on the bead or slide based on PCR extension using the attached DNA as the templates. All extension reactions have a failure rate, and as the reaction continues, the probability that all the strands in a cluster are at the same length (no failures to extend) decreases with length of product, so the signal generated by this cluster tends to becomes mixed and incoherent the longer the read becomes, and is usually responsible for the limit on the length of the ‘read’ (sequence) generated by the process. To address this, many sequencers now record a quality score for each base reaction and these read q-values can be used to pre-filter data going into downstream analysis. In another example, these sequencers somehow detect the addition of a base to the read sequence, but differ in what is actually measured.

Both Roche 454 and Ion Torrent add a single base and record what clusters added that base by measuring a by-product of the polymerization step. Roche measures the pyrophosphate produced, while Ion Torrent measures the pH change generated from the breakdown of the pyrophosphate. Both of these approaches have problems with homopolymer runs (multiples of one base) with difficulties in determining the exact number of identical bases in a row, and tends to make the cluster incoherent, generating problems with all downstream sequencing.

Illumina uses fluorescently labeled bases that have been modified so that no additional bases can be added to the labeled base without treatment. Thus each base is a single color and homopolymers are not as much of a problem. After recording the base added, a chemical treatment is used to remove the fluor and the blocker so additional bases can be added. The efficiency of this clearing process affects the coordination of reactions within a cluster, thus the length and quality of the generated reads. All 3 techniques use a polymerase to add bases to the sequence strand (sequencing by extension-SBE), so the accuracy of the polymerase affects the accuracy of the subsequent read and conditions that influence polymerase processivity, such as G/C content, strongly influence ability of these approaches to sequence specific DNA regions. These issues with polymerase may also arise at the level of library preparation, so it can also show up strongly in these SBE processes.

SOLiD is very different as it anneals fluorescently labeled octamers to the template strand, tagged to denote 2 bases within the octomer. Thus this process does not rely on polymerases to add bases to the growing sequence strand, eliminating many of the polymerase associated errors during the sequencing reactions, but polymerases are still utilized in the library preparation. The other major difference is that the color of the octamer does NOT reflect a base, but rather the transition between 2 bases. Thus the data from this instrument is not a string of bases, but a string that reflects change from base 1 to base 2, base 2 to base 3, etc. There is known logic surrounding these color calls, so once the first base in the sequence is known, all the other bases can be determined according to the base transition calls. Thus SOLiD sequencing may be better for mutation analysis, as each base change requires 2 color calls (B2=B1>B2 and B2>B3), as opposed to the base-linked calls from the SBE methods where a single bad call results in a mutation call. Most analysis of SOLiD sequence data is done in ‘color space’, where the reference sequence is converted in the appropriate color transition patterns. The advantage is that incorrect color calls can be identified and corrected (based on read matching to downstream sequences), a process that is not available in SBE approaches. However, SOLiD still falls short in providing the level of accuracy and scope needed for many analytical studies.

Darwinian evolution, based on genetic alterations to produce the phenotypic variations that provide relative fitness advantage under changing environmental conditions, is observed in many clinical situations, where treatment is often the selective pressure. Under these types of conditions, a relatively rare subpopulation that is treatment resistant, will rapidly expand once sensitive populations are eliminated, generating a difficult clinical scenario. Examples include development of HAART resistant HIV populations within a given patient or generalized antibiotic resistance. This type of population dynamics is also observed in cancer, whose hallmark feature is genetic instability at all levels of DNA organization: chromosomal ploidy and translocations, copy number variation (CNV) or loss of heterozygosity (LOH) of limited regions, as well as single nucleotide variations including small insertions and deletions. While cancer has long been considered a clonal process, recent studies have demonstrated that genetic instability generates subclonal populations whose numbers wax and wane depending on their relative fitness within the tumor environment. The majority of these mutations are predicted to have no influence on cell behavior (passenger mutations) while the relatively rare mutations that provide a selective growth and/or survival advantage (driver mutations). These genetic variants are proposed as the source of both ongoing tumor progression leading to aggressive transformation and development of treatment resistance.

Thus, there is a need in the art to accurately identify and quantify rare genetic variants within a population. The present invention satisfies these needs.

### SUMMARY OF THE INVENTION

A method of identifying genetic variants within a population of sequences is described. The method includes the steps of aligning a set of sequence data reads to reference sequences, dividing reference sequences into multiple tracks of overlapping regions of analysis (ROAs), partitioning each read into a ROA, identifying a plurality of sequence patterns in the reads, setting a sequence pattern frequency threshold value, eliminating any sequence pattern that has a value below the frequency threshold value, forming a plurality of dictionaries from the sequence patterns having a value above the frequency threshold value, and cross-validating sequence patterns via partial sequence assembly.

In one embodiment, the method further includes the step of generating alternate reference alleles from verified sequence patterns that occur above a set frequency to form a custom reference set. In another embodiment, the method further includes the step of iteratively re-aligning the sequence data reads to the custom reference set. In another embodiment, each ROA is unique. In another embodiment, the ROAs are in a single track. In another embodiment, each sequence pattern is unique. In another embodiment, each sequence pattern is counted with regard to strand and occurrence from each strand. In another embodiment, the sequence patterns are cross-validated via dictionaries from overlapping ROAs. In another embodiment, cross-validating sequence patterns via partial sequence assembly can generate an additional classification of sequence patterns. In another embodiment, the additional classification of sequence patterns is verified, ½ verified but kept, non-verified and discarded. In another embodiment, the sequence pattern frequency threshold value is at least 2 in each sequence direction.

A method of characterizing genetic diversity in a population of cells is also described. The method includes the steps of aligning a set of sequence data reads from a cell to reference sequences, dividing reference sequences into multiple tracks of overlapping regions of analysis (ROAs), partitioning each read into a ROA, identifying a plurality of sequence patterns in the reads, setting a sequence pattern frequency threshold value, eliminating any sequence pattern that has a value below the frequency threshold value, forming a plurality of dictionaries from the sequence patterns having a value above the frequency threshold value, cross-validating sequence patterns via partial sequence assembly, and determining genetic diversity of the cell based on at least one identified genetic variant.

In one embodiment, the population of cells is a tissue. In another embodiment, the tissue is a tumor. In another embodiment, the population of cells comprises tumor subpopulations. In another embodiment, the tumor subpopulations are determined at least at the 0.4% level. In another embodiment, the determination has at least an 80% sensitivity for genetic mutations.

A system for identifying genetic variants within a population of sequences is also described. The system includes a software or hosted platform executable on a computing device, wherein the software or hosted platform is programmed to align a set of sequence data reads to reference sequences, divide reference sequences into multiple tracks of overlapping regions of analysis (ROAs), partition each read into a ROA, identify a plurality of sequence patterns in the reads, set a sequence pattern frequency threshold value, eliminate any sequence pattern that has a value below the frequency threshold value, form a plurality of dictionaries from the sequence patterns having a value above the frequency threshold value, and cross-validate sequence patterns via partial sequence assembly. In one embodiment, the software or hosted platform is programmed to generate alternate reference alleles from verified sequence patterns that occur above a set frequency to form a custom reference set. In another embodiment, the software or hosted platform is programmed to iteratively re-align the sequence data reads to the custom reference set.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIG. 1 is a flow chart of existing sequencing data analysis methods.

FIG. 2 is a flow chart of an exemplary method of identifying and quantifying genetic variants within a population of sequences.

FIG. 3 is a flow chart of another exemplary method of identifying and quantifying genetic variants within a population of sequences, according to the present invention.

FIG. 4 is a flow chart identifying the threshold based filtering components of the method shown in FIG. 3.

FIG. 5 is a flow chart identifying the partial assembly and verification of dictionaries components of the method shown in FIG. 3.

FIG. 6 is a chart depicting dividing reference sequences into regions of analysis, where reads that completely cover the ROA are uniquely assigned to a single ROA for computational purposes. There are 1000s of reads mapped to any given ROA. The image shows SEQ ID NOs: 1-10.

FIG. 7 is a chart depicting the unique sequences within each ROA being collected and counted. This ROA-linked histogram of words is called a dictionary. A threshold filter is applied to each word. The image shows SEQ ID NOs 11-17.

FIG. 8 is a chart depicting a compilation of a complete collection of ROA dictionaries and verification of entries. FIG. 8 depicts covering the reference sequence with a set of overlapping ROAs to assign all mapped reads and form a collection of dictionaries. The image shows SEQ ID NOs 18-29.

FIG. 9 is a chart depicting dictionary entries that are compared in order to classify them as verified (match found for both sides), retained (used to verify a neighbor), or dropped (neither side matches). The image shows SEQ ID NOs 30-44.

FIG. 10 is a series of charts depicting the frequency distribution of calls with various applied filters.

FIG. 11 is a chart depicting a logistic regression model of method sensitivity. 10M reads were randomly selected from two specimens in proportions ranging from 1:31 to 31:1, mapped using BFAST and analyzed using the ROA threshold and verify procedure. A set of 71 indicator mutations from the pure specimens that had pure specimen frequencies ranging from 5% to 40% in Bcl2 were selected. The presence (1) or absence (0) of each of the indicator mutations in the various blends is plotted against their diluted frequencies on a log scale (non-informative data above 2% and below 0.05% are not shown). A logistic model was fit to this data using the mnrfit function from the MATLAB Statistics Toolbox (The MathWorks, Natick, Mass.) to estimate the sensitivity of the method as a function of specimen mutation frequency; also shown are 95% confidence limits around the model curve. This model indicates that the method has an 80%±10% sensitivity for mutations occurring at a frequency of 0.4% indicated by the circle on the model plot. The data also indicates the method is unlikely to observe SNVs below the lowest observed frequency recovered from the blend (0.25%), where a modeled sensitivity of 30%±14% is marked by a square.

FIG. 12 is a chart depicting the quantification of subclones that allows phylogenetic trees to be enhanced with proportionality data which illustrates population dynamics.

FIG. 13 is a chart depicting the partition of reference sequence into ROAs and read assignment. The reference sequence is divided into ROAs starting at a set position, according to chosen ROA size and desired overlap. Reads are assigned to ROA according to BAM alignment information, based on the read sequence completely covering the ROA endpoints, with trimming of excess sequence (greyed bases). (A) This diagram represents an ROA Collection with 2-tracks of abutting ROAs of size 34 bases with a second track that overlaps the first by one-half (17 bases). The reads are uniquely assigned to one track such that abutting and overlapping ROAs from a single collection contain independent sets of reads. In this case, 50 base reads are divided into ROA of 34 bases with 17 base overlap. The image shows SEQ ID NOs 45-57. (B) This diagram represents a second ROA Collection with an offset start site of one-half the overlap, which in this case is 9 bases. The sequence differences in read sets generated by this alternate partitioning are denoted by vertical arrows. Partitioning the reads into different ROA collections increases the ability to confirm SNVs in regions with severe differences in coverage. The image shows SEQ ID NOs 46, 48-49, 51, and 53-60.

FIG. 14 depicts the effects of threshold and cross-validation filters on SNV determination. FIG. 14A depicts plasmid fragment controls, generated by restriction enzyme digestion and gel purification of pBluescript II KS, were spiked into FL specimen pooled amplicons at 1/10 the concentration of the individual targeted gene amplicons. Aggregating the aligned read data from the 10 FL specimens after mapping with BFAST, resulted in an average location coverage of 45,000×, in which there were 989 observed raw candidate SNV calls discovered (black line). Application of either the bidirectional minimum word threshold frequency filter (squares) or verification by cross-validation (diamonds/dashed) alone dropped the candidate SNV call counts to less that 10% of the raw calls, while application of both filters had a synergistic effect, eliminating >99.5% of the initial calls (4/989—triangles). Each curve represents a histogram with 4 bins per decade. FIG. 14B depicts the IGH data from the 10 FL specimens were aggregated in a similar manner, resulting in 45426 raw candidate SNV calls (black line) with a lesser reduction following cross-validation (18684 remaining or 41% —diamonds/dashed), a similar reduction following thresholding (4714 or 10% —squares) and a combined reduction to 1948 final SNV calls (>4% —triangles) following application of both threshold and cross-validation filters. Note that the combination of filters retains the vast majority of SNV calls which were present at frequencies >1%. Reads were mapped to the Sanger-level sequence of the clonal IGH from each FL specimen so SNVcalls represent SHM generated variation around the clonal sequence of each specimen and does not represent changes from germline sequence.

FIG. 15 depicts the construction of additional alleles for iterative mapping. Designing ROA collections with overlapping dictionaries facilitates limited partial assembly of sequences, which are used in a cross-validation process to classify sequence patterns as part of signal filtering for SNV identification. Additionally, assembled sequences can be selected to enrich the reference pool to include high confidence variants and allow better capture of reads centered on any given ROA that contain a high density of mutations. Considerations include generating the appropriately sized alternate reference fragment for read alignment and the variant frequency threshold for inclusion in the reference pool. The use of 34 base ROAs required only the inclusion of neighboring overlapping sequences to generate 68 base allelic fragments suitable for mapping 50 base reads to focus on variations observed in the central ROA. The image shows SEQ ID NOs 30-36, 38-44, and 61-73.

FIG. 16 depicts mutation density, coverage, and mutation frequency data for BCL2 in Specimen 128. (A) 35 base moving average percent identity of Sanger sequence for BCL2 to its GRCh37.p10 reference has a minimum value of 75% identity. (B) Local coverage relative to reference location for initial BFAST mapping (open circle) and converged iterated BFAST mapping (black triangle) shows improved coverage in areas with lower percent identity; coverage in controls (solid line), with 5000 offset, shows typical non-uniform coverage pattern. (C) Frequency of SNVs (# mutated reads/total # reads) called by analysis of initial BFAST (open circle) and converged iterated BFAST (black triangle) are plotted versus reference location. This alignment data shows a wide range of frequencies and a general increase in detected frequency with iterative mapping, most easily observed near horizontal arrows (2) and in cluster on far right. Iterative remapping also identified an additional 18 SNVs (22.5% increase). Note that a large number of mutations share a common frequency, representing the founder genotype present in the majority of tumor cells (bold black arrow). (D) Cumulative frequency distribution data plotted as rank (1 to 80 for initial BFAST, 1 to 98 for converged iterated BFAST, high to low frequency) shows the increase in the number of mutations detected and a tighter distribution of founder SNV frequencies upon iteration (bold black arrow). Two homozygous SNPs are present in this sample (at SNV Frequency=1).

FIG. 17A depicts the influence of mutation patterns, alignment tool and iteration on evolution of clonal IGHV sequence. BSBSBn refers to a mapping pattern of twice alternating BFAST and SHRiMP, followed by BFAST iterated n-times, where n=1-3. FIG. 17B is a comparison of SNV calls for FL specimens identified by different methods. Aggregate is the count of unique SNV calls as determined by any method. Single BFAST are results from single round of mapping with DDiMAP SNV algorithm. Iterative BFAST are results from iterative remapping to convergence with DDiMAP SNV algorithm. BSBn are results from sequential rounds of BFAST and SHRiMP2 mapping, followed by BFAST mapping to convergence with DDiMAP SNV algorithm.

FIG. 18, comprising FIGS. 18A-18B, is a chart depicting homozygous SNP data.

FIG. 19 is a table of SNV identified by DDiMAP according to sample type and gene target, with BCL2, BCL6, IGH-enh, RHOH and PAX5 showing differential mutation rates in FL compared to controls.

FIG. 20 is a table depicting contingency data for BCL2 SNV calls consistent with somatic hypermutation patterns.

FIG. 21 depicts the effect of mapping algorithm and ieration on read coverage in IGHV regions. Coverage (in thousands of reads per location) versus position within the FWR1 to FWR3 regions of the identified IGHV in six specimens with varying overall mutation rates. A. Specimen 128, IGHV 1-18, 7.3% mutation; B. Specimen 133, IGHV 3-48, 14.2% mutation; C. Specimen 134, IGHV 3-48, 15.3% mutation; D. Specimen 139, IGHV 3-48, 16.3% mutation; E. Specimen 136, IGHV 3-15, 17.3% mutation; F. Specimen 132, IGHV 1-46, 17.7% mutation. These plots show differences in mapping coverage between SHRiMP2 (square) and BFAST (circle) mapping when using germline sequences as the reference without iteration and the improvement in coverage obtained using BSBSBn iterative mapping (triangles) wherein BFAST and SHRiMP2 are alternated twice, followed by four additional BFAST iterations. Note how initial mapping coverage is lower in the CDR regions which typically are more highly mutated, but as the overall mutation rate increases, large regions including FWR as well as CDR show severe loss of coverage due to the inability of the alignment programs to handle the clustered deviations from reference. Iterative alignment using both mapping algorithms provides highly significant additional coverage.

FIG. 22 depicts example dendrograms for BCL2 from verified words in ROA dictionary for locations 171-204. These dendrograms depict an inferred evolutionary relationship between putative subclones, showing relative population fraction using circle area and genetic distance from the reference by horizontal displacement. Mutations are noted by position and called SNV. A. Seven clones are found in specimen 128 using BFAST without iteration in which an ambiguous evolutionary history of the most frequent clone (MFC) is seen along with a single descendant. Mapped coverage is 14623 reads. B. Five clones are found in specimen 128 by iterating BFAST to convergence (4 mapping iterations) in which the most frequent clone has two low frequency descendants. Mapped coverage is 15492 reads. C. Seven clones are found in specimen 128 by starting with BFAST, following by SHRiMP, and then iterating BFAST to completion (BSBn method, 4 mapping iterations) in which a 5.7% clone and its 0.3% descendant containing mutations at two adjacent positions (202 and 203) were revealed by SHRiMP. Mapped coverage is 15594 reads.

FIG. 23 depicts the listing of primers used to amplify genetic regions of interest. The image depicts SEQ ID NOs: 74-102. Location according to GRCh37.p13 at www.ncbi.nlm.nih.gov, accessed 10/09/2013.

FIG. 24 is a graph depicting how identified BCL2 SNV patterns at both high and low frequencies match AID-induced somatic hypermutation patterns. AID somatic hypermutation signature is well characterized, preferentially altering C or G at WRCY/RGYW motifs (W=A/T, R=A/G, and Y=C/T) resulting in C/G> to G/C or T/A mutations. The proportion of (C+G) sites in BCL2 region that are part of an AID motif is 14%. SNVs in BCL2 from the 12 FL specimens were classified as ‘motif’ only if both the SNV occurred at WRCY/RGYW and resulted in the preferred mutation pattern of C/G >G/C or C/G to T/A. All 3 groupings of BCL2 SNV calls (total, frequency ≧15% and frequency <1%) show a consistent and highly significant utilization of WRCY/RGYW motifs at 3-times their proportion in BCL2, p<0.0001 for all groupings. Similar analysis was performed for AW/WT motifs. Again, all 3 categories of SNV frequency distributions were highly consistent, and skewed towards the POLH motif with p≦0.0015. Results were compared by Fisher's exact onetailed analysis performed at http://graphpad.com. Contingency tables for these data are in may be found in FIG. 27.

FIG. 25 is a graph depicting that iteration is the major contributor to enhanced SNV discovery in regions with high mutation density. This figure demonstrates the influences of alignment program and iteration on the ability to identify SNVs in the densely mutated BCL2 region from specimen 128, with an SNV rate of 13.9%. The bars represent SNVs called by the given discovery method as a percentage of the aggregate number of novel SNVs identified by any method. BFAST is the primary alignment tool, used either singly (BFAST-1x), iteratively to consensus (BFAST-nx) or alternatively with SHRiMP, followed by BFAST to consensus (BSB-nx). Iteration to consensus alone increased SNV identification by >23% over single run BFAST alignment, while adding SHRiMP with iteration increased SNV calls by >30% over single run BFAST.

FIG. 26, comprising FIGS. 26A-26H, depicts frequency distributions comparing SNV and Word Data yield 3 patterns. These plots show frequency data for verified words (gray) and called SNVs (black) in BCL2 from eight FL specimens. A homozygous SNP is present in all cases and a heterozygous SNP is present in all but 134 (FIG. 26E). In all cases, the mutation pattern of the MCF can be observed as a group of tightly clustered frequencies that would be detectable in Sanger sequence data. In FIGS. 26A-26F, there are several to many SNVs (black line) that are present at lower frequencies, whereas in FIGS. 26G and 26H only one or no SNVs are present below 5%. The additional words (gray line) seen in FIGS. 26G and 26H at lower frequencies contain only SNVs present in the most frequent clone (MFC), representing MFC ancestors. In FIGS. 26A-26F, the density and clustering of SNVs affects the relative shapes of the word and SNV plots. In FIGS. 26A-26D additional low frequency SNVs occur in the same ROA as high frequency SNVs, representing primarily descendants of MFC, increasing the proportion of the words contain the high frequency SNV. In FIGS. 26E and 26F, the additional low frequency SNVs occur primarily in ROAs that do not contain high frequency SNVs, representing possible divergent diversity, and the word and SNV plots essentially overlay.

FIG. 27, comprising FIGS. 27A-27F, depicts contingency data for BCL2 SNV calls consistent with somatic hypermutation patterns. FIGS. 27A-27C depict detail SNVs at C and G for their consistency with the canonical AID motif, defined as C/G at the underlined base in WRCY/RGYW sites changed to either A/T or G/C. Tables D-F detail SNVs patterns at A and T for their consistency with the POLH mutation patterns, defined as A>X or T>X at underlined base in WA/TW sites. FIGS. 27A and 27D show total SNV data, while FIGS. 27B and 27E look only at SNVs at frequencies ≧15%, and FIGS. 27C and 27F look at SNV frequencies at ≦1%. All SNV data show a highly significant and consistent tendency to the AID-mediated mutation patterns, implying that the extremely low frequency SNVs calls represent a biological process and are not due to analytical error. The Fisher's exact one-tailed analysis performed at http://graphpad.com.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical sequencing analysis platforms. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

“Words” as used herein mean particular sequence patterns of nucleotide letters.

“Dictionaries” as used herein mean collections of words with additional metadata such as frequencies of occurrence in a particular context.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

### DESCRIPTION

The present invention includes a system and method for analyzing next-generation short read data (50-100 basepairs) at ultra-deep levels (˜10,000×) for the identification and quantification of rare genetic variants within a test population. The present invention may be used in any field where rare variant analysis is desired. For example, in one embodiment, the present invention may be used to analyze subclonal populations within follicular lymphoma, which is a lymphatic cancer of relatively mature B-lymphocytes. In another embodiment, the present invention identifies and characterizes tumor diversity. In another embodiment, the present invention can determine tumor subpopulations at a level limited only by the underlying instrumental error rate and depth of sampling. Illustratively, in an embodiment using coverages at ˜10000× and an instrumental error rate of 0.1%, the level at which half the variants are detected is as low as 0.3%. In another embodiment, the present invention may also provide information that describes tumor evolution. In other embodiments, the present invention may be used in non-clinical settings, such as population based studies where the ability to insure identification of rare individuals increases the depth of the study.

### Nucleic Acid Samples and Preparation

As contemplated herein, the present invention may be used in the analysis of any nucleic acid sample for which next generation sequencing may be applied, as would be understood by those having ordinary skill in the art. For example, in certain embodiments, the nucleic acid can be, without limitation, genomic DNA (whole genome sequencing), a subpopulation of DNA captured by annealing fragmented genomic DNA to well-designed probes matching coding regions only (exome sequencing), or targeted re-sequencing using PCR to amplify specific regions of genomic DNA. Other variations can include capturing mRNA and using reverse transcriptase to convert this into DNA for subsequent sequencing (whole transcriptome analysis or RNA-seq).

The nucleic acid may be prepared (e.g., library preparation) for massively parallel sequencing in any manner as would be understood by those having ordinary skill in the art. While there are many variations of library preparation, the purpose is to construct nucleic acid fragments of a suitable size for a sequencing instrument and to modify the ends of the sample nucleic acid to work with the chemistry of a selected sequencing process. Depending on application, nucleic acid fragments may be generated having a length of about 100-1000 bases. It should be appreciated that the present invention can accommodate any nucleic acid fragment size range that can be generated by a sequencer, simply by dividing the reads into segments and assigning the read segments into abutting (but not overlapping) ROAs. This can be achieved by capping the ends of the fragments with nucleic acid adapters. These adapters have multiple roles: first to allow attachment of the specimen strands to a substrate (bead or slide) and second have nucleic acid sequence that can be used to initiate the sequencing reaction (priming) In many cases, these adapters also contain unique sequences (bar-coding) that allow for identification of individual samples in a multiplexed run. The key component of this attachment process is that only one nucleic acid fragment is attached to a bead or location on a slide. This single fragment can then be amplified, such as by a PCR reaction, to generate hundreds of identical copies of itself in a clustered region (bead or slide location). These clusters of identical DNA form the product that is sequenced by any one of several next generation sequencing technologies.

Next, the samples are sequenced using any standard massively parallel sequencing platform, as would be understood by those having ordinary skill in the art. For example, sequencers may include Roche 454, Illumina HiSeq 2000 or 2500, SOLiD, and the like.

### Method

As contemplated herein, the present invention includes a method of detecting sequence variation. Generally, sequence reads are aligned, or mapped, to a reference sequence using readily available commercial software or open source freeware as would be understood by those having ordinary skill in the art (e.g., color space or nucleotide and quality data input, mapped reads output). This may include preparation of read data for processing using format conversion tools and optional quality and artifact removal filters before passing the read data to an alignment tool. Next, the aligned reads are filtered to remove false positive base change calls (e.g., mapped reads input, summarized filtered sequence data output). Next, variants are called (e.g., summarized data input, variant calls output) and interpreted (e.g., variant calls input, actionable information output).

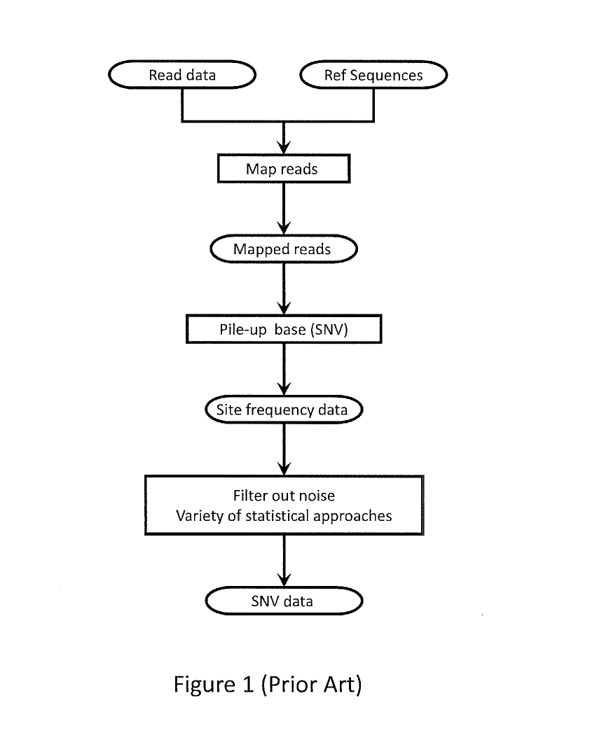

Prior to describing the variant calling component of the present invention, a review of standard approaches to mapping and analysis of this type of massively parallel sequence data is provided, which is illustrated generally in FIG. 1. Read data are mapped to Reference sequences using any number of mapping software, and using appropriate alignment and sensitivity settings suitable for the goal of the project. Once the reads are aligned to the reference sequence, the total numbers of base calls at each location are summed using algorithms such as mpileup in SAMTOOLS. From this “pile-up” of sequence data, various non-reference calls are identified and the frequencies of these variants are determined based on the total number bases assigned to that particular location, generating site frequency data. Once all the reads are coalesced into site frequency data, various statistical models, which can be quite extensive, are used to eliminate false base calls. Often these models incorporate run-specific negative controls to identify systematic errors within the given run. Results from these invariant controls, in conjunction with specific error models of polymerase mis-incorporation and known instrument error patterns are used to set a frequency threshold that variant calls must reach to be considered true positives. Non-reference base calls that pass the various filters become simple/single nucleotide variant calls. Most variant calling software currently used at commercial next generation sequencing vendors use a 5% frequency threshold for variant calls.

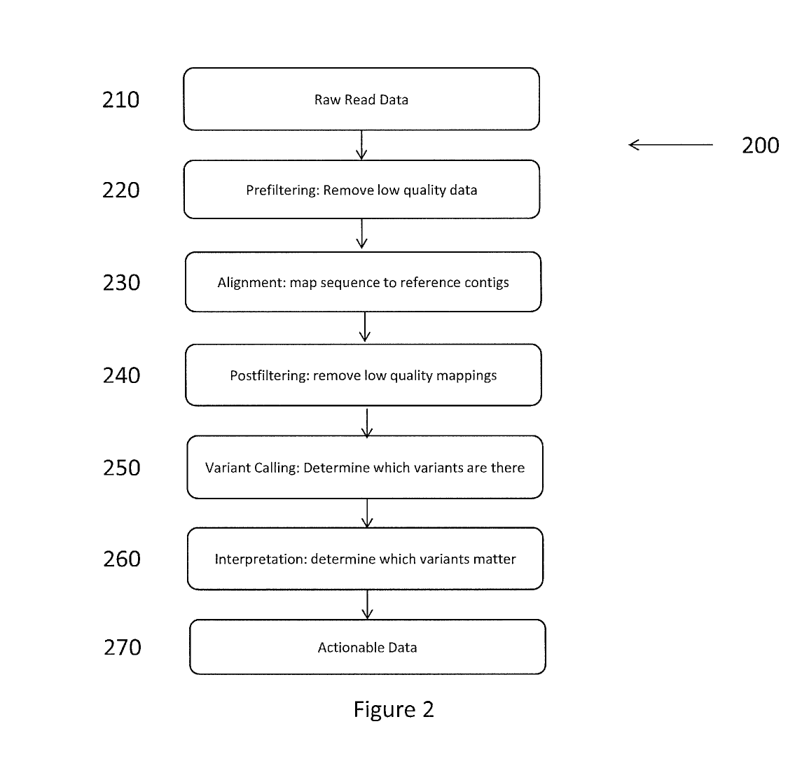

In a more general functional description, an analytical pipeline may detect sequence variation as generally outlined in the method 200 of FIG. 2. First, raw read data 210, which may include sequence and quality information from the sequencing hardware, is received and entered into the system. The data is optionally prefiltered 220, for example, one read at a time or in parallel, to remove data that is too low in quality, typically by end trimming or rejection. The remaining data is then aligned 230 using a set of reference sequences to determine which sequence and where within that sequence a read best aligns, which may further include providing a mapping quality along with the location information. Mapped reads may optionally be postfiltered 240 to remove low quality or uncertain mappings. In certain embodiments, such prefiltering, alignment and postfiltering steps may be performed independently for each read to exploit massively parallel computational capability. A collection of mapped reads may then be used in variant calling 250, wherein the read information is examined to determine what locations contain variants, such as (without limitation) base substitutions, insertions, or deletions relative to the reference sequence. The variant calls may then be interpreted 260 to determine which variants represent innocuous variation and which represent substantial variation, resulting in actionable data 270.

It should be appreciated that alignment (step 230), whereby reads are assigned to a location within the reference sequence, is a critical aspect in detecting sequence variation, particularly in subclonal sequence populations. Most alignment tools are designed to identify the common genotypic variants called simple or single nucleotide polymorphisms (SNPs) which occur at either 0% (not found on either chromosomal allele), 50% (found on 1 allele) or 100% (found on both alleles) in any given individual; variations that are typically sparsely spaced within the reference sequence and occur at relatively high frequency or not at all. In contrast, the analysis of rare variants must allow the identification of low frequency events, and in the case of malignant tumors where mutation events are often clustered within a given region, allow mapping of reads with significant differences from the reference sequence. If mapping criteria are too stringent, reads containing the mutations of interest will not be mapped and thereby lost to further analysis, as false negatives. If mapping criteria are too lenient, allowed mis-mapping of error-filled reads would generate potential false positives. In order to reach the goal of providing quantitative estimates of both common and rare variants in specimens from tumors, the present invention utilizes settings set forth in method 200 of FIG. 2 that permit mapped read data from regions with closely spaced variation (high density of mutations) from the reference sequence and occurring at low frequency within the population of reads from any given specimen.

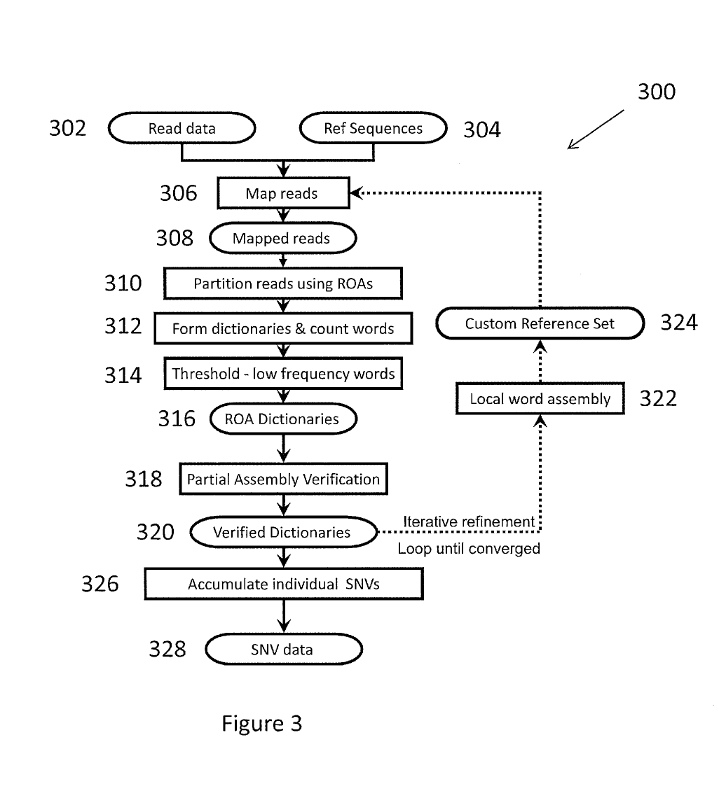

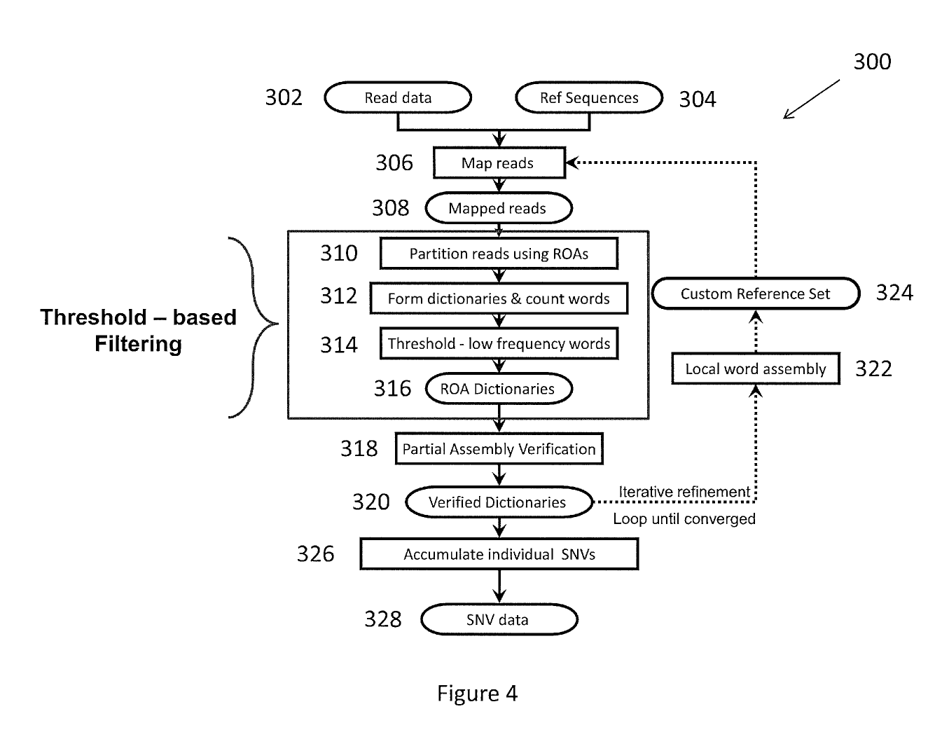

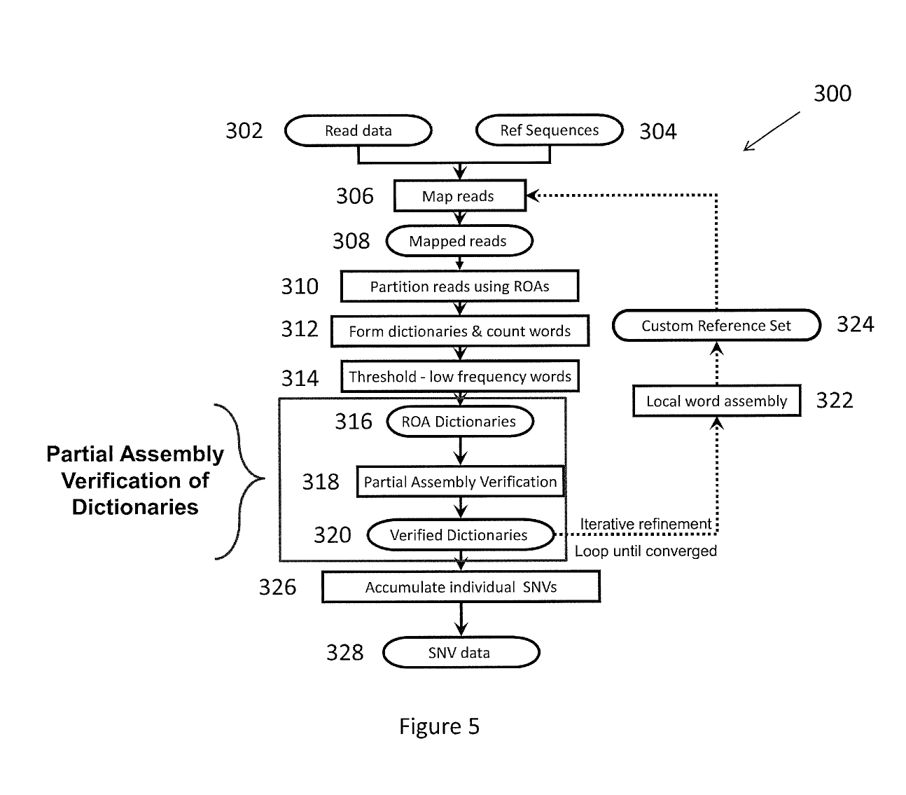

FIGS. 3-5 are a more detailed schematic representation of the method of the present invention for identification and quantification of rare variants using massively parallel sequencing data, illustrating both the threshold—based filtering steps (FIG. 4) and partial assembly and verification steps (FIG. 5). As shown in FIGS. 3-5, the process 300 may include the following steps. First, reads 302 are aligned to reference sequences 304 in block 306 to produce aligned reads 308 using a mapping program optimized for the sequence data at hand, and capable of allowing a reasonable degree of flexibility in mapping stringency. Next, reference sequences 304 are divided into multiple tracks of overlapping regions of analysis, or ROAs, mapped reads are partitioned 310 uniquely to a track, and reads or read segments are assigned into unique ROAs in a single track. Next, unique sequence patterns contained in the reads or read segments within each ROA are identified (words) and these words are counted with regard to strand and occurrence from each strand 312. Words occurring below set frequency thresholds are eliminated 314. Remaining words and their count statistics form the ROA dictionary 316. Next, dictionaries from overlapping ROAs are used to cross-validate words via partial sequence assembly 318, generating an additional classification of words (verified, ½ verified but kept, non-verified and discarded) 320. Next, alternate additional reference alleles are generated from verified words that occur above a set frequency in a local word assembly step 322 to produce a custom reference set 324 which is used in place of the original reference set 304 for remapping in block 306 in the next iteration through blocks 306 to 320 but the original reference set 304 is used for defining the ROA partitioning in 310. In one embodiment, these additional alleles in the custom reference set 324 are obtained by embedding partially assembled verified word data within a copy of the original reference allele to preserve alignment to the original reference allele. In a preferred embodiment, partially assembled verified word data are used to generate fragments along with known alignment to the original reference allele that are of sufficient length to accommodate mapping entire reads within them. Reads mapped to these allele fragments are aggregated using their known alignment along with reads mapped to the original sequence when assigning them to ROAs in 310. This enhanced set of reference sequences is used for mapping and analysis, and this is repeated until no new variants are identified above the set frequency or a maximum number of iterations is reached. Once iteration is terminated, in block 326 the nucleotide sequence of the verified words and their associated word counts are employed to accumulate the number of occurrences of each nucleotide or deletion call at each position across the original set of reference alleles. For each nucleotide or deletion call that differs from the original reference allele nucleotide and for which a non-zero count is obtained is a SNV call candidate that may be placed in the SNV data 328, which comprises the location, the reference allele nucleotide, the called variant, and the frequency. In a preferred embodiment of the process 300, a set of overlapping tracks offset from the first may be simultaneously processed, providing a set of verified dictionaries 320 which may also be used to generate additional alleles by partial word assembly 322 to produce a larger custom reference set 324. When an additional set of verified dictionaries is produced for each additional set, the SNV accumulation in 326 may proceed using words from multiple dictionaries at each location separately. In this case, the accumulating step 326 will produce multiple frequency estimates for each detected SNV that may be added to the SNV data along with identifying information to permit further analysis.

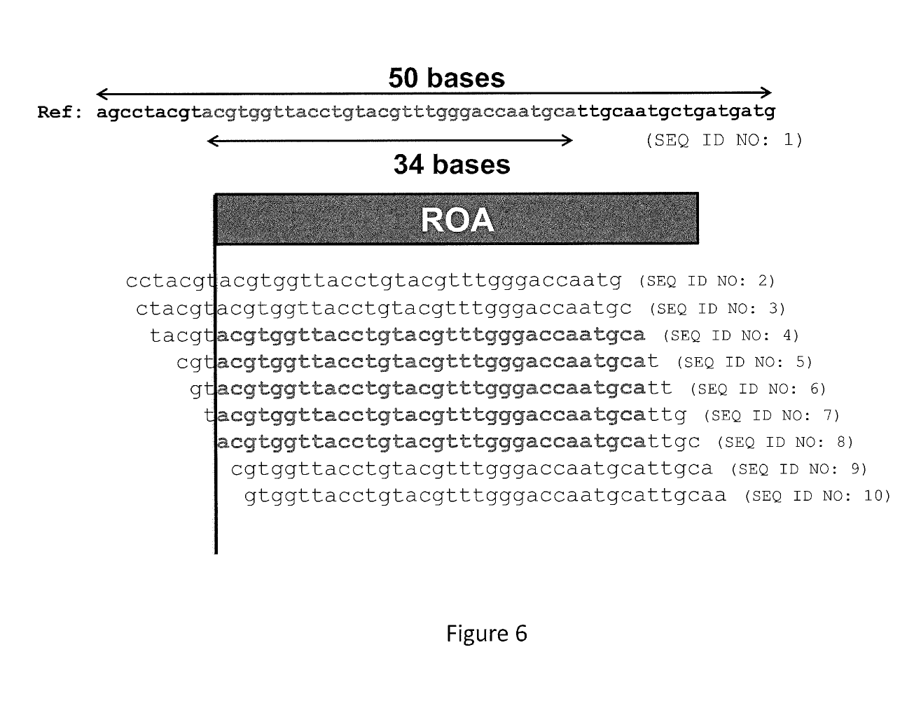

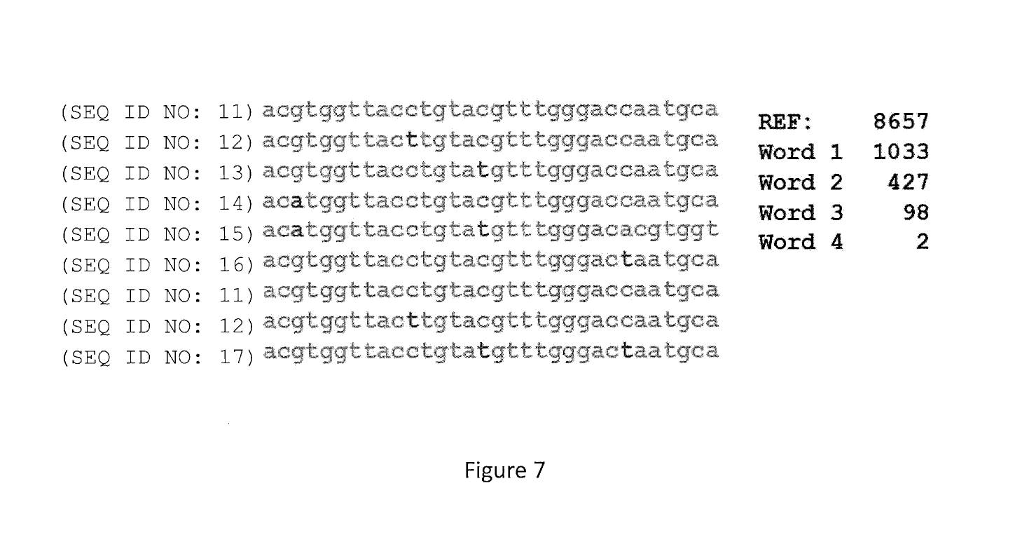

During threshold filtration, the reference sequence is divided into computational units called “Regions of Analysis,” as shown in FIG. 6. These ROAs are manipulated by the same processes, so the work is highly parallel for high throughput computation. Reads are assigned to a ROA by one rule: the sequence must completely cover the ROA. Once the 1000s of reads are assigned to a ROA, one can look at the sequence variation within the set of reads, as shown in FIG. 7. Each unique sequence variation (‘word’) is identified and counted, along with the number of reads that describe the reference frequency (listing of ref and words 1, 2, 3, 4, along with # observations in tabular form on right). The set of word sequences and observations are associated with each ROA, and called the ‘dictionary’ for that ROA. FIG. 7 also shows the same ROA with an associated word list and frequency. In one embodiment, a first level of threshold-based filtering rule may be: must see variant sequence at least twice from both sequencing directions, independent of coverage. Once a certain coverage level is obtained, the bidirectional filter becomes a minimum frequency based on coverage. For example, word 4 is below minimal observation requirements, so this word sequence may be eliminated from the ROA dictionary.

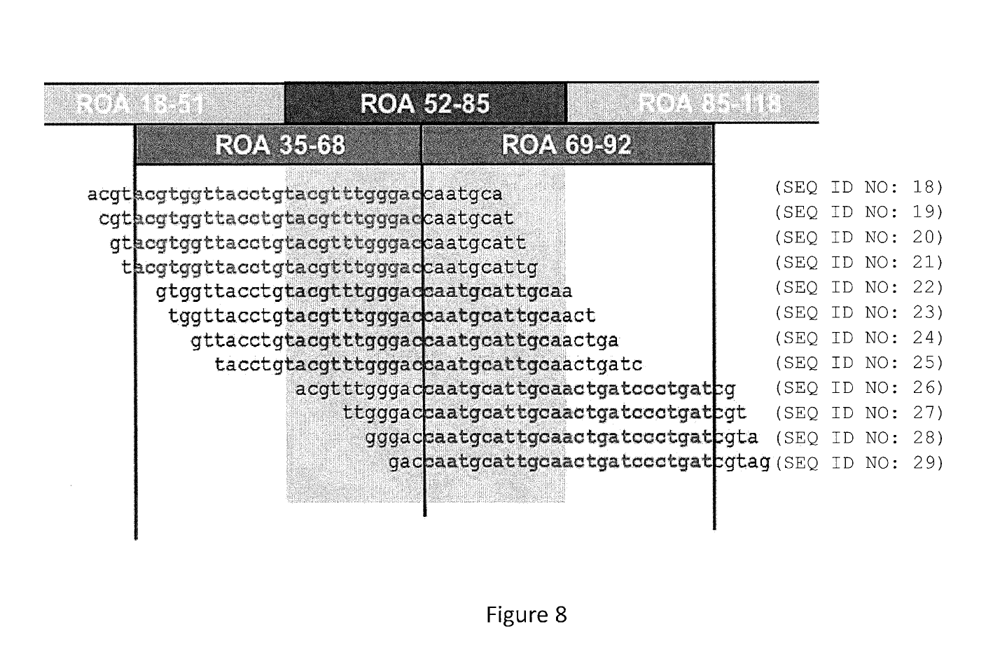

As mentioned elsewhere herein, the present invention includes a partial assembly, and verification of dictionaries, of sequence patterns for cross-validation of observed variants from independent sets of reads. These steps are included because random noise is highly variable, while true mutations are reproducibly observed in independent sets of reads, even if at very low levels. FIG. 8 shows neighboring ROAs with their associated reads. It should be noted how reads associated with the blue ROA (35-68) cannot associate with the Green ROA (69-92), and that there are reads (text) that are not included in either neighboring ROA. To ensure all read data is included in the analysis, a second level of ROA is constructed that overlap the neighboring ROA by exactly ½. The Red panel shows the limits of the Red ROA (52-85), and the sequences assigned to the Red ROA are illustrated as red (sequences that completely cover the red ROA). In certain embodiments, all reads may be utilized, and all reads may be assigned to 1 and only 1 ROA. Thus, the partial sequences in any given ROA may be comparable to the partial sequences in overlapping neighboring ROAs.

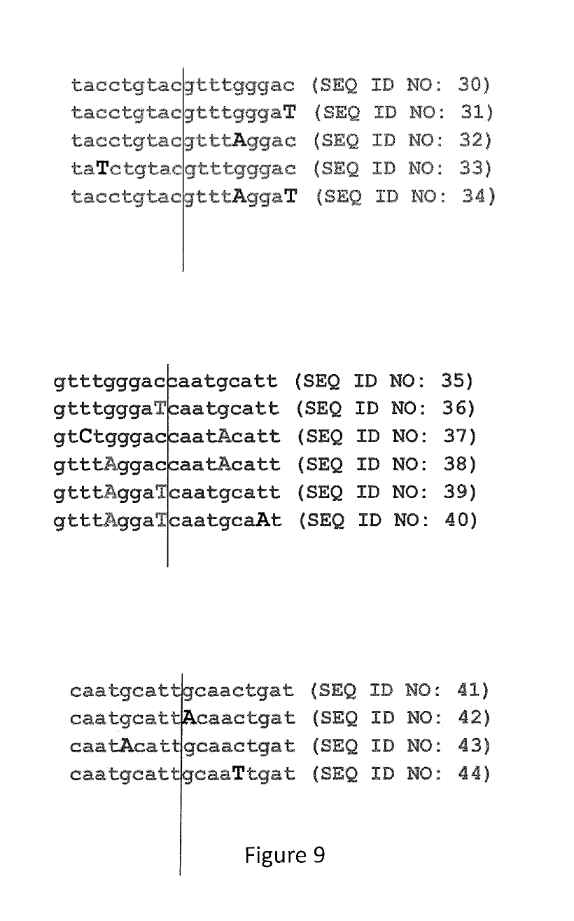

FIG. 9 depicts overlapping sequence regions, where the focus is on verifying the Red ROA (52-84) using sequence information from the neighboring blue and green ROAs (35-68 and 69-92, respectively). The lines show the overlap regions. The sequences on the left side of the Red ROA dictionary can be compared to the right side of the Blue dictionary. It should be noted how the Red and Blue mutation calls can be observed in both the blue and red dictionaries, while the black ‘C’ mutation (Red ROA only) call is not observed in the blue dictionary, so this sequence may be eliminated from the Red ROA Verified dictionary (but maintained in the Red dictionary from the basic threshold filtering—non-verified dictionary). It is also noted that the same can be said about a black ‘A’ mutation on the right side of the Red ROA dictionary. This word can then be eliminated from the Red ROA verified dictionary. This process (moving down the reference sequence one ROA at a time) generates a verified dictionary for each ROA containing both the sequence variations with their associated frequencies.

It is important to note that a significant problem with NGS is that the strings of sequence (reads) generated by the sequencing instrument have no value and cannot be evaluated until the read is linked to a reference sequence at a set location, through a traditional mapping or alignment process. Algorithms that perform this alignment assign penalties to putative read-reference location assignments based on each occurrence where the reference and read sequences disagree, and once the penalties reach a critical threshold, that read is judged to not align (to not be a match) to that reference sequence and is discarded from further consideration. The reference sequences used herein are initially taken from international databases, and are considered to be representative of what most healthy people's sequence would be at a given location, within population considerations. In the case of cancers, it is known that the genomes of tumor cells differs from normal, healthy people due to higher mutation rates, loss of high fidelity DNA repair, and/or loss of cell division check points that monitor DNA replication quality before allowing cell division to proceed. Thus reference sequences can be a poor alignment tool when using NGS to evaluate cancer genomes, especially when the cancer genome contains regions with high mutation densities as the very reads that contain the evidence of high mutation levels will often be discarded from further consideration due to their lack of identity to the international reference sequences, as they accrue too many penalties based on alignment algorithms.

The present invention provides a solution to this loss of the critical read data, particularly with regard to tumor heterogeneity studies via iterative re-mapping (See iterative refinement loop in FIGS. 3-5). For example, the present invention may use high confidence SNV (base differences) results to make an additional reference sequence that contains these base differences from the database references and re-align all of the read data. The iterative process of aligning read data, analyzing for SNV calls, making additional reference sequences that contain high confidence SNVs (that occur at frequencies of >1% for example) is repeatable until no novel SNV calls are made above the high confidence threshold. By doing so, it has been found that more reads get aligned to the augmented references, and that previously mapped reads are ‘better’ aligned to specific locations when provided with the optimal representative sequences from the tumors.

Accordingly, NGS has two significant problems with discerning rare variants that are corrected via the system and methods of the present invention. First is the high error rate in the sequence data, which is address by the present invention through a model-free threshold and cross-verification filtering method based on keeping sequence variation within their string context (word-based). Second is the problem of data loss due to ineffective mapping processes eliminating reads reflecting highly mutated/highly divergent genomic sequence. The present invention corrects this by using the word-based approach to easily augment the reference sequences to include previously discovered and verified sequence differences.

It should be appreciated that iterative re-mapping is not required to perform the novel approach to identify signal within noise, and that it may be optionally used, as iteration plays a valuable role in the ability to analyze densely mutated/highly divergent sequences.

Accordingly, the system and method of the present invention may be applied to high throughput sequencing technology read data from a variety of sequencing platforms without limitation, including Illumina HiSeq, Life Technologies Ion Torrent, and others.

Read data may be mapped to reference sequence collections using a variety of alignment tools without limitation, including SHRiMP, Novoalign CS, and many others, separately or in combination. For example, it was found that using SHRiMP for alignment allows discovery of some closely spaced variants that are not seen using BFAST, but that alignment using BFAST allows discovery of variants in higher variant density regions than SHRiMP. This suggests that combining results may result in more complete discovery and improved allele variant enrichment.

Read length may be shorter or longer or even of variable size as long as unique assignment of a read to an ROA track is observed, with read splitting over multiple abutting ROA windows allowed within a track to provide more flexibility in ROA size choice and greater utilization of read data. For example, use of ROAs of length 50 with a read length of 75 results in loss of 25 potential base pairs worth of data, whereas use of two ROAs of length 30 reduces this loss to 15.

Any number of ROA tracks may be used, and need not be limited to two, allowing for more cross validation options in the verification step according to the nature of the overlap between tracks, trading off against reduced coverage of each track. For example, use of four tracks with an ROA size of 40 with track offsets of 10 allows for use of more complex verification rules in conjunction with variable overlap sizes afforded by the extra tracks.

Allele variant enrichment may be accomplished by adding partially assembled sequence fragments separately to the reference sequence pool for alignment as long as they are of sufficient length to allow alignment, requiring coordination of ROA dictionary formation across reference sequence fragments derived from a single original reference sequence rather than full sized sequences containing one or more modified sections. A modestly increased complexity in dictionary formation code is offset by greater efficiency in alignment resulting from use of a smaller number of bases in the reference sequence collection.

### System Platform

As contemplated herein, the present invention includes a system platform for performing the aforementioned methods for analyzing sequencing data at ultra-deep levels, for example, for the purpose of identifying and quantifying rare genetic variants within a test population.

In some embodiments, the system of the present invention may operate on a computer platform, such as a local or remote executable software platform, or as a hosted internet or network program or portal. In certain embodiments, only portions of the system may be computer operated, or in other embodiments, the entire system may be computer operated. As contemplated herein, any computing device as would be understood by those skilled in the art may be used with the system, including desktop or mobile devices, laptops, desktops, tablets, smartphones or other wireless digital/cellular phones, televisions or other thin client devices as would be understood by those skilled in the art. The platform is fully integratable for use with any sequencing platform and data output as described hereinthroughout.

For example, the computer operable component(s) of the system may reside entirely on a single computing device, or may reside on a central server and run on any number of end-user devices via a communications network. The computing devices may include at least one processor, standard input and output devices, as well as all hardware and software typically found on computing devices for storing data and running programs, and for sending and receiving data over a network, if needed. If a central server is used, it may be one server or, more preferably, a combination of scalable servers, providing functionality as a network mainframe server, a web server, a mail server and central database server, all maintained and managed by an administrator or operator of the system. The computing device(s) may also be connected directly or via a network to remote databases, such as for additional storage backup, and to allow for the communication of files, email, software, and any other data formats between two or more computing devices. There are no limitations to the number, type or connectivity of the databases utilized by the system of the present invention. The communications network can be a wide area network and may be any suitable networked system understood by those having ordinary skill in the art, such as, for example, an open, wide area network (e.g., the internet), an electronic network, an optical network, a wireless network, a physically secure network or virtual private network, and any combinations thereof. The communications network may also include any intermediate nodes, such as gateways, routers, bridges, internet service provider networks, public-switched telephone networks, proxy servers, firewalls, and the like, such that the communications network may be suitable for the transmission of information items and other data throughout the system.

Further, the communications network may also use standard architecture and protocols as understood by those skilled in the art, such as, for example, a packet switched network for transporting information and packets in accordance with a standard transmission control protocol/Internet protocol (“TCP/IP”). Any of the computing devices may be communicatively connected into the communications network through, for example, a traditional telephone service connection using a conventional modem, an integrated services digital network (“ISDN”), a cable connection including a data over cable system interface specification (“DOCSIS”) cable modem, a digital subscriber line (“DSL”), a T1 line, or any other mechanism as understood by those skilled in the art. Additionally, the system may utilize any conventional operating platform or combination of platforms (Windows, Mac OS, Unix, Linux, Android, etc.) and may utilize any conventional networking and communications software as would be understood by those skilled in the art.

To protect data, an encryption standard may be used to protect files from unauthorized interception over the network. Any encryption standard or authentication method as may be understood by those having ordinary skill in the art may be used at any point in the system of the present invention. For example, encryption may be accomplished by encrypting an output file by using a Secure Socket Layer (SSL) with dual key encryption. Additionally, the system may limit data manipulation, or information access. For example, a system administrator may allow for administration at one or more levels, such as at an individual reviewer, a review team manager, a quality control review manager, or a system manager. A system administrator may also implement access or use restrictions for users at any level. Such restrictions may include, for example, the assignment of user names and passwords that allow the use of the present invention, or the selection of one or more data types that the subservient user is allowed to view or manipulate.

As mentioned previously, the system may operate as application software, which may be managed by a local or remote computing device. The software may include a software framework or architecture that optimizes ease of use of at least one existing software platform, and that may also extend the capabilities of at least one existing software platform. The application architecture may approximate the actual way users organize and manage electronic files, and thus may organize use activities in a natural, coherent manner while delivering use activities through a simple, consistent, and intuitive interface within each application and across applications. The architecture may also be reusable, providing plug-in capability to any number of applications, without extensive re-programming, which may enable parties outside of the system to create components that plug into the architecture. Thus, software or portals in the architecture may be extensible and new software or portals may be created for the architecture by any party.

The system may provide software applications accessible to one or more users to perform one or more functions. Such applications may be available at the same location as the user, or at a location remote from the user. Each application may provide a graphical user interface (GUI) for ease of interaction by the user with information resident in the system. A GUI may be specific to a user, set of users, or type of user, or may be the same for all users or a selected subset of users. The system software may also provide a master GUI set that allows a user to select or interact with GUIs of one or more other applications, or that allows a user to simultaneously access a variety of information otherwise available through any portion of the system.

The system software may also be a portal or SaaS that provides, via the GUI, remote access to and from the system of the present invention. The software may include, for example, a network browser, as well as other standard applications. The software may also include the ability, either automatically based upon a user request in another application, or by a user request, to search, or otherwise retrieve particular data from one or more remote points, such as on the internet or from a limited or restricted database. The software may vary by user type, or may be available to only a certain user type, depending on the needs of the system. Users may have some portions, or all of the application software resident on a local computing device, or may simply have linking mechanisms, as understood by those skilled in the art, to link a computing device to the software running on a central server via the communications network, for example. As such, any device having, or having access to, the software may be capable of uploading, or downloading, any information item or data collection item, or informational files to be associated with such files.

Presentation of data through the software may be in any sort and number of selectable formats. For example, a multi-layer format may be used, wherein additional information is available by viewing successively lower layers of presented information. Such layers may be made available by the use of drop down menus, tabbed pseudo manila folder files, or other layering techniques understood by those skilled in the art or through a novel natural language interface as described hereinthroughout. Formats may also include AutoFill functionality, wherein data may be filled responsively to the entry of partial data in a particular field by the user. All formats may be in standard readable formats, such as XML. The software may further incorporate standard features typically found in applications, such as, for example, a front or “main” page to present a user with various selectable options for use or organization of information item collection fields.

The system software may also include standard reporting mechanisms, such as generating a printable results report, or an electronic results report that can be transmitted to any communicatively connected computing device, such as a generated email message or file attachment. Likewise, particular results of the aforementioned system can trigger an alert signal, such as the generation of an alert email, text or phone call, to alert a manager, expert, researcher, or other professional of the particular results. Further embodiments of such mechanisms are described elsewhere herein or may standard systems understood by those skilled in the art.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore, specifically point out the preferred embodiments of the present invention, and are not to be construed as limiting in any way the remainder of the disclosure.

### Example 1

### Mutation Analysis

The following experiment was a targeted resequencing project that used PCR to amplify regions of the genome suspected to have undergone mutations within a tumor and thereby serve as a measure of mutagenic stress present in the tumor environment.

### Sample Preparation

Test samples included 12 follicular lymphoma (FL) specimens, a type of B-cell tumor, 3 hyperplastic lymph nodes (HP) as a source of non-malignant polyclonal B-cells, all obtained as de-identified samples from the Human Hematological Malignancy Tissue Bank at URMC in accordance with institutional IRB protocols, and HEK 293 as a source of clonal non-lymphoid tissue.

### Targeted Genomic Regions

The following genomic regions were targeted for analysis:

1) IgH, which encodes the clonal specific immunoglobulin expressed by all B-cells. Due to B-cell specific chromosomal rearrangement, this molecule is the equivalent of a B-cell fingerprint and can be used as a tumor specific marker for FL specimens. Previous studies have shown that this gene undergoes ongoing mutation in FL, thus is an internal positive control for these studies. However, since this product identifies clones, it has no value in the polyclonal mixture found in HP specimens, thus this is only used in FL.

2) Emu, an intronic region within the IgH gene which can be amplified from all specimens.

3) 10 non-IgH regions based on previous studies that suggest their susceptibility to mutation within this type of tumor.

Each amplicon was 1 kb on average, generating approximately 16 kb sequence per specimen, dependent on the clonal specific IgH gene.

### Experimental Conditions

A high-fidelity polymerase (pfu) was used along with a sufficient amount of template DNA (equivalent to ˜40,000 cells) so that an error that occurred during first round of amplification (<1:40,000) would still be below expected mutation detection limits (1:1000).

A sufficient amount of template DNA was used to represent genomic DNA from 40,000 cells, to provide the statistical basis to consider a 0.1% population.

A polyclonal B-cell population was used from the same tissue type as the tumor to test for clinical utility. B-cells undergo mutational events as part of their normal physiology. This was needed to see if the assay found events (total number, gene frequency differences, subpopulation identification) that were distinct from those observed in their normal counterparts.

A plasmid fragment (KS), generated by enzymatic digestion and gel purification, was included as a negative control. A small sample was spiked into each patient specimen before library preparation as an internal control for library preparation induced variation as well as analytical pipeline development

PCR amplicons were generated from each specimen under routine conditions, cleaned, quantified using Nanodrop 1000, and mixed in equimolar amounts. These specimen specific pools were concatenated by blunt-end ligation to ensure equivalent representation of amplicon ends in the library preparation. The library preparation and SOLiD 4 run was performed by the Functional Genomic Center at URMC in accordance to ABI/manufacturer's directions. ABI SOLiD 4 color space read data was received and provided in the form of csfasta and qual files for each specimen. Each specimen generated approximately 8-10 million reads resulting in approximately 25000× coverage of the reference sequence of the targets.

### Alignment of Reads to Target Reference Sequences

Since ABI SOLiD 4 was used to provide the test data in the form of 50 bp unpaired reads, a color space aware alignment tool was used to process the data. For example, two open source tools, BFAST and SHRiMP2, were evaluated for alignment during performance of the method of the present invention. Both BFAST and SHRiMP2 are designed to provide accurate alignment in settings that include a high degree of polymorphism in the reads. Both use Smith-Waterman alignment algorithm at their core, but make different decisions along the way and provide different settings for tuning.

### Preparation of Reference Sequence Data for Alignment

Sequences for the 10 non-IgH reference sequences were obtained from NCBI human sequence build 36.3 (www.ncbi.nlm.nih.gov), while KS plasmid negative control sequence was obtained from Sanger sequencing. Individual IgH reference sequence for all tumor derived specimens was generated using Sanger sequencing of the Vh-J6 PCR amplicon, with any ambiguous bases (2 bases at one location) resolved to the germline sequence for the Vh and/or corresponding J region that were recombined to generate the functional IgH gene. Part of the library preparation involved concatenation of the PCR products, including the KS control, generating ‘artificial sequences’ consisting of 3′ ends of amplicons randomly ligated to 5′ ends of other amplicons, generating additional tail-to-head sequences in the samples to be sequenced at 50 bp length. To provide alignment targets for such recombinant sequences, additional reference sequences comprising the final 49 bases and initial 49 bases of all possible amplicon pairings within a single specimen were added to the reference sequence collection.

### Preparation of Read Sequence Data for Alignment

ABI SOLiD 4 color space read data provided in the form of csfasta and qual files for each specimen were combined into fastq files using the solid2fastq utility distributed with BFAST. Both BFAST and SHRiMP use fastq files as input. If any read quality based filtering is desired prior to aligning with BFAST, any of a number of preprocessing tools such as the FASTX-Toolkit (hannonlab.cshl.edu/fastx_toolkit/index.html) may be used to eliminate reads with low quality calls or to trim ends of reads that are often of lower quality or have a bias. SHRiMP offers a built-in low average quality filter (defaults at average Phred score 10) and drops reads with missing data.

### Running the Alignment Tools

Both BFAST and SHRiMP take advantage of parallel processing. Workstation class machines were used running 64 bit linux on quad-core Intel i7 CPUs using hyperthreading and with 16 GB RAM. The output from these tools is in the form of “.sam” files which were sorted and compressed using SAMTOOLS before further processing.

### Basic Variant Calling Procedure

Existing styles of analysis (outlined in FIG. 1), where the sequence patterns within any given read is lost with data processing, is considered a location-centric approach. The heuristic approach of the present invention for processing reads after alignment is reference-centric, and takes advantage of the statistical power present in the ordered pattern of nucleotides found in independently generated reads, as the probability of randomly generating any given nucleotide sequence of length n is (¼)ⁿ, which is on the order of 1:17 billion for the segment length of n=17 used in this current analysis. By using preparation techniques designed to minimize introduction of sequence errors early in the process, it is assumed that the majority of read error variation (noise) is due to library formation and instrumental errors modifying the underlying true sequence. To examine and preserve patterns of variation present in the reads, the reference sequences were divided into computational units called regions of analysis (ROAs). The ROAs are chosen to be short enough to be entirely covered by individual reads starting at several locations upstream and downstream from the ROA borders, yet long enough to detect lack of linkage typical of false discovery events arising from errors, as shown in FIG. 6. Reads that completely fill the borders of the ROA may be assigned to that computational unit. For reads longer than 2 abutting ROAs, the read can be divided into segments and each segment may be uniquely assigned.

Within each ROA, subsections of the assigned reads covering that ROA, which are also referred to as words, are collected into a dictionary for that ROA, with counts of exactly matching words tallied separately for forward and reverse strands. Each dictionary is seeded with the nucleotide sequence corresponding to the reference sequence and each word is compared to all words already in the dictionary, tallied if already present, or added as a new word if not. For example, as shown in FIG. 7, the initial computations performed in the ROA are to evaluate the 10-1000s of read segments assigned to the ROA to determine the number of unique sequence patterns (words), tally the occurrence and the strand direction (forward or reverse) of that word in any given read. By this highly parallel process, the reads may be compressed into the minimal list that contains the entire sequence complexity of that ROA, enabling computational efficiency. The first level of threshold filtering can then be performed on these ROA dictionaries.

Although it is possible to choose an ROA arbitrarily, ROAs may preferably be chosen in a coordinated manner as shown in FIG. 8. For any given starting position on a reference sequence, a set of abutting equal sized ROAs is laid out to cover as much of the reference as possible without overhanging the end. While not required, preferably the ROA has a length that is a multiple of 2 so that a second set of abutting ROAs can be laid out at an offset exactly half their length. Aside from the ends of the reference sequence, each location is covered by two ROAs and blocks of locations of equal size occur in their overlap zones. For a given dual track ROA collection, reads covering blocks of positions may be assigned in a way that every mapped read is uniquely assigned to an ROA track in which it covers one or more ROAs. For example, as shown in FIG. 8, read alignments are to a reference sequence location and subsequent read segment assignment to overlapping ROAs from 2 offset tracks. ROA size can be varied to best accommodate experimental parameters. For experiments described herein using read lengths of 50 bp, ROA lengths of 34 with a 17 bp overlap facilitates assignment of all reads to a unique ROA. In certain embodiments, no single read can contribute sequence segments to overlapping ROAs.

In this case, any read without indels covers exactly one ROA on one track and does not cover any ROA on the other, so the unique track assignment criterion is easily enforced. A read whose mapping includes a deletion from the reference sequence may be mapped over a larger portion of the reference sequence and thus may extend into a second ROA on the alternate track, and so an additional rule may be provided to resolve the ambiguity, namely that the track chosen is the one whose ROA is closest to the start of the read. A read whose mapping contains an insertion is mapped to a smaller portion of the reference sequence and even if its extent is longer than the ROA size, it may still fail to completely cover an ROA and it cannot be used. It should be appreciated that if a different start location for a dual track ROA collection had been chosen, such a read could be utilized. Similarly, if a longer ROA were chosen, some reads would not completely cover an ROA on either track. If a shorter ROA, for example of size 20, were chosen, then a read without indels would cover two ROAs in one track and one or even two ROAs in the other track. The rule used to handle deletions would then apply, assigning the read to the track associated with the ROA closest to the read start. Even though such a read would provide words for multiple ROA dictionaries, the ROAs do not overlap. Accordingly, there is no limitation to the ROA size other than being greater than one and not greater than the nominal read length, as the present invention can accommodate any such variation in preferred ROA size.

Once the dictionaries are formed in all ROAs from all tracks, total coverage and individual word counts may be used to classify the words. A number of rules used in the art to classify pileup variant data at a single location may be applied at a word level. For example, a strand bias filter would remove words that occur entirely or predominately on one strand. In another example, a rarity filter would remove words that occur so rarely that it is likely the pattern contains variants not present in the specimen. Thresholds used in such filters may be applied separately to forward and reverse counts, as well as to their total, and the thresholds used may be dependent upon location coverage. The key advantage of word based analysis using dual track ROA collections according to the present invention is that it provides additional means to compare patterns after applying threshold based filters to eliminate suspect patterns.

In embodiments where read data is never duplicated across tracks, words in a dictionary for a ROA in one track may be split in half and matched to half-words from the dictionaries of the overlapping ROAs in the other track to perform a statistically valid cross-validation via partial-assembly of sequences, as shown in FIG. 8. Words in which both halves are validated may be called “verified” words. Words in which only one half is present in an overlapping ROA may be classified as “kept” words. Words which are not validated in either half may be dropped entirely due to lack of any corroborating evidence. Once all the dictionaries are examined, a pileup may be performed to provide statistics for each variant, counting only variants occurring in verified words or counting both verified words and validated halves of kept words.

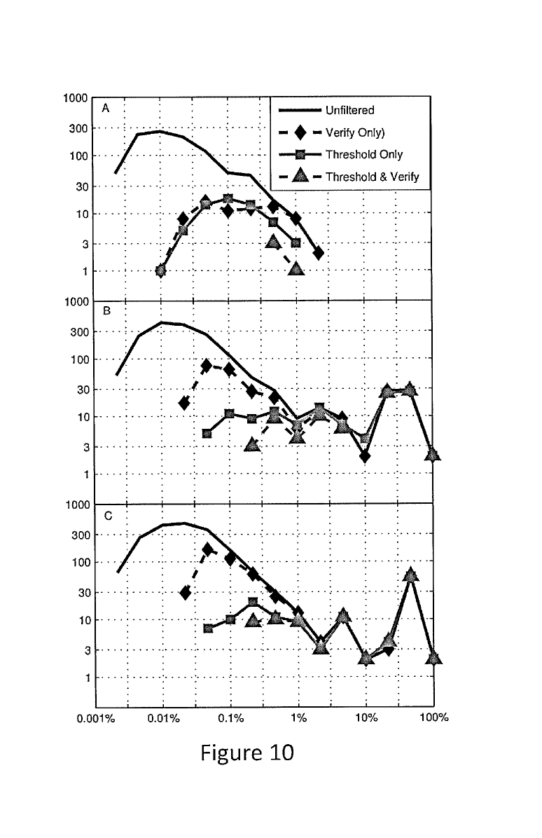

As contemplated herein, when looking for rare variants in a population, true positives should be distinguished from random and systematic patterns of introduced variation. Since the verification process of the present invention provides another opportunity to remove patterns attributable to noise, in certain embodiments, the frequency-based threshold filters may be set at lower levels than if they were the only filter available for reducing false discovery rates. Conversely, since the verification process alone is capable of preserving systematic variation regardless of rarity, a frequency-based threshold filter remains necessary. As shown in FIG. 10, the effectiveness of these filters applied separately and together is illustrated. For example, the curves represent the frequency distribution of variants called for two of the twelve target regions used in the experiment described herein using BFAST with default or recommended settings to perform the alignment of the reads to the reference sequences. The distribution of variants seen is shown before any filters are applied, after either threshold based or verification based analysis is applied, and with both applied. In FIG. 10A, variants seen in the negative plasmid control KS pooled over all specimens containing the KS target region are shown. While there are variants seen across a wide range of frequencies, the majority occur at frequencies below 0.5% as would be expected for background signal. Neither strategy alone is effective at removing all variants, but the combination leaves very few presumably false discovery events behind. These may be due to actual polymorphism in the plasmid, which occur at a copy number of nearly 500 in the E. coli host, or an idiosyncratic replication error in sample preparation. Further, base substitution and deletion frequency data was binned using 3 bins/decade and plotted on a log-log scale to show effects of the filters used. As shown in FIG. 10A, (where KS is a negative control), reads mapped to the 1045 bp spiked KS target lead to 989 single nucleotide variant, or SNV, observations before any filtering was applied. When overlapping ROA dictionary cross-validation was applied to verify these calls, all but 71 were eliminated. When 750 ppm bidirectional frequency thresholding for individual patterns was applied instead, 62 remain. If both filters were applied, only 4 remain. This is a reduction to <99.5% of original calls. In FIG. 10B, SNVs observed in a Bcl2 target region from one of the tumor specimens are shown. Again, there are a very large number of SNVs called, but the number is substantially higher than that seen in KS, indicative of the presence of true variants. Again, the combined strategy was more effective than the individual components, but in this case, a significant post-filtered signal remains. The shape of the retained SNVs distribution was markedly different, representing various subclonal populations. The high frequency spike was characteristic of the dominant clone within the tumor population, in addition to a wide range of rare variants at lower frequencies that represent ongoing mutation events or remnants of diverse populations than have been outgrown. If a threshold only based strategy were employed, a setting large enough to effectively eliminate the KS false discovery signal of approximately 1.5% would also eliminate the bulk of the rare variant population in the Bcl2 target in the specimen. In specimens without tumors, their Bcl2 picture matched KS (data not shown). Reads mapped to an 850 bp Bcl2 promoter region from the FL specimen with the highest mutation density led to 1658 observed mutations before any filtering is applied. Verification alone reduced this number to 292, thresholding alone reduced it to 123, and both filters jointly reduced it to 86. The effects of iterative remapping with additional reference alleles are shown in FIG. 10C. Reads mapped for the same Bcl2 sample with three generations of iterative mapping applied to enhance mapping sensitivity showed an increase in the unfiltered count to 1936 from 1658, with verification alone reducing it only 481, thresholding alone to 134, and both filters to 105. Note in all 3 panels that the vast majority of calls were from extremely low frequency events, as would be expected for random noise, and that these calls are specifically and effectively eliminated by the application of filters. The shapes of the distributions are affected by the absence or presence of signal (A vs B) and by the iterative process (B vs C).

### Tuning the Procedure

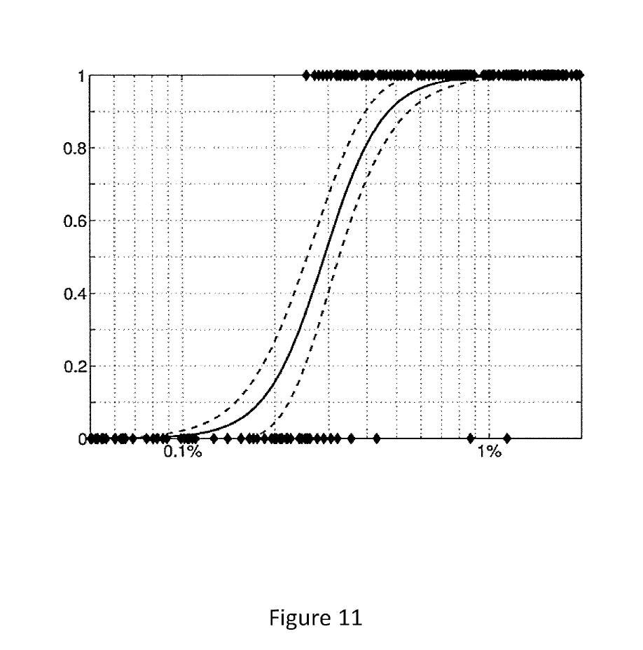

The thresholds that may be employed in the variant calling procedure trade off sensitivity and specificity in the context of the post-threshold verification process. Word frequency thresholds were set using a combination of a fixed threshold of at least two occurrences in each read direction (strand bias) and a variable threshold based on coverage (rarity). One approach that may be taken to tune such a process is to examine how the trade offs perform in dilution of known positive samples with known negative samples in the context of noise. This was done by blending read data from two samples with distinct variants, randomly selecting 10⁷ reads from their population at blend ratios from 1:31 to 31:1. For a given threshold, the presence or absence of each variant call was fit using a logistic regression wherein the log of the theoretical frequency computed using the pure specimen frequency and the blend ratio was used as the predictor, as shown in FIG. 11. It was found that at a threshold of 750 ppm, the variant calling procedure has an 80% sensitivity at a frequency of 0.4% and a 95% sensitivity at a frequency of 0.7% with little additional power obtained for thresholds below that level without seeing an undesirable increase in the false discovery rate in KS. As shown in FIG. 11, 10M reads were randomly selected from two specimens in proportions ranging from 1:31 to 31:1, mapped using BFAST and analyzed using the ROA threshold and verify procedure of the present invention. A set of 71 indicator mutations from the pure specimens that had pure specimen frequencies ranging from 0.3% to 40% in Bcl2 were selected. The presence (1) or absence (0) of each of the indicator mutations in the various blends is plotted against their diluted frequencies on a log scale (uninformative data above 2% and below 0.05% are not shown). A logistic model was fit to this data to estimate the sensitivity of the method as a function of specimen mutation frequency. Also shown are 95% confidence limits around the model curve. This model indicates that the method has an 80%±10% sensitivity for mutations occurring at a frequency of 0.4%.

### Validation of High Frequency Results

Over 90% of the SNVs seen at high frequency were validated using Sanger sequencing, with 92% of the variants seen in the Sanger data called at a frequency over 20%. The bulk of the Sanger variants not seen (16/21) were in locations with very high mutation density, with two or three variants seen over a space of three locations, and in one case, with 9 variants seen over 15 locations. Examination of the mapping output indicates that these reads were lost in the mapping process, partially due to color error correction strategies employed by BFAST. When the Sanger variants were introduced into the reference sequence collection, the corresponding reads were found to be present and mapped to the variants. Other variants seen with Sanger but missed were at locations where coverage was low or changing drastically.

### Variant Calling Procedure Enhancements

The Sanger validation results motivated two changes in the procedure—1) feedback of discovered variants and 2) shifting of ROA locations. First, the fact that seeding the reference sequence with the Sanger methodology identified SNVs resulted in the detection of those variants, led to the realization that if the target sequence from patient specimens was too different from the reference sequence, mapping would fail to align reads to regions of high density mutation. To fully capture these reads of interest, it was decided to incorporate results from a first variant calling run to generate additional alternate alleles into the reference sequence pool. It was noticed that Sanger calls near the edge of high density mutation areas were occasionally present at a lower than expected frequency, but that they were found at the expected frequency when they were added to the reference sequence pool. That suggested that the mapping and variant calling procedure can be able to detect variants further into higher density mutation areas by adding these variants. Second, the fact that some Sanger variants were detectable with an ROA collection starting at one location and not another lead to the consideration of examination of multiple start locations.

In order to introduce variant patterns into the reference sequence pool, a partial assembly process was used by taking a verified word containing a call and assembling it with the overlapping words used to verify it. These partially assembled sequence fragments were 68 bases long, sufficient for a read containing that variant sequence to be mapped there. For convenience in processing the read mapping data, the fragments were embedded into several backbones of surrounding reference sequence with a minimum distance between embedded fragments on any one backbone chosen to ensure that a read could not straddle portions of multiple fragments. A number of these alternate alleles are also needed to handle the number of variant words seen in some ROAs. Not all verified words were used in this procedure, rather a higher threshold, illustratively 1% rather than 750 ppm, was chosen at which there was low risk of seeding the process with false discovery variant patterns. A single iteration of this process was somewhat effective, and so it was decided to iterate the process until no further changes were seen in the dictionaries. The feared effect of a runaway process did not occur, with convergence attained in the most densely mutated cases in four iterations. The desired outcome of finding all Sanger calls did not occur, with the verified fraction increasing from 86% to 92%. Dibase adjacent variants were resistant to discovery unless a subclonal variant with one but not both SNV was present. Examination of read result data indicated that BFAST was reverting color calls associated with dibase and tribase variants, color changes spanning three or four transitions, to preserve reference sequence.

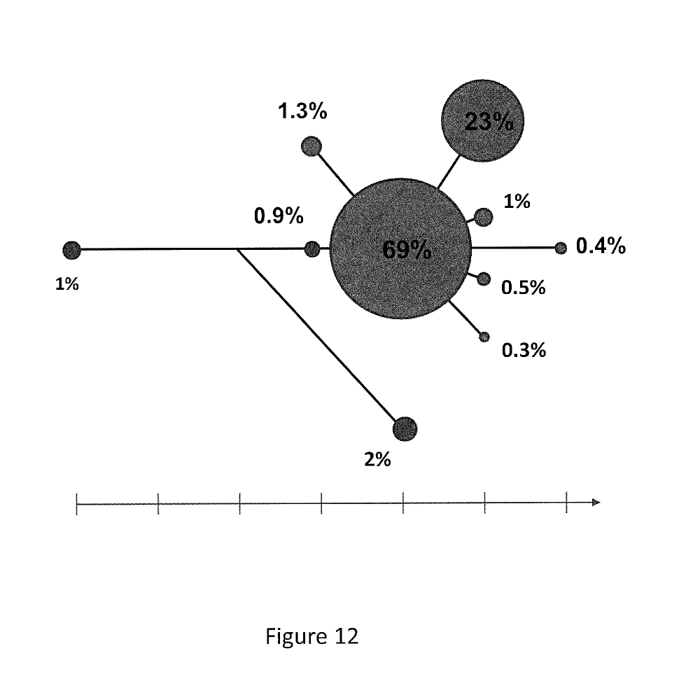

Additional benefits were discovered. The 68 base fragments from overlapping ROAs were of sufficient length to use for phylogenetic analysis, and to characterize tumor subclonal populations with regard to evolutionary development, identify dominant subclones and presence of ongoing mutation. This provides the ability to characterize subclonal populations with regard to evolutionary traits in clinical evaluation of cancers. For example, FIG. 12 shows a phylogenic analysis of subclonal tumor population based on ROA dictionary analysis of IgH sequence from an FL specimen. Partially assembled words from neighboring ROAs with associated frequency data were used to generate the phylogenetic relationships. The large subclonal population evolving from the dominant clone was evident, as were multiple smaller subclones, illustrating ongoing mutation at that location within that tumor.

An additional benefit to iteration was the improvement in frequency estimations. There were some homozygous SNP variants in the specimens that were reported at approximately 90% using the baseline reference collection that were reported at 99.8% once they were added as alternate alleles in the reference sequence. This is consistent with the error detection and correction behavior of BFAST. If any of the color reads near the SNP are in error, then the color pattern of an isolated variant (two color differences in a row that are consistent with the surrounding bases) is disrupted by a read error in any one of four positions—the two changed by the variant and the two neighboring positions. In such cases, BFAST would revert the sequence to reference. When the alternate allele is present, BFAST will detect and appropriately correct such a color error in order to map it to the alternate allele. It is also noted that variants associated with the tumor clone as well as heterozygous SNPs also have a tighter distribution of frequencies after iteration, consistent with the presence of subclonal populations sharing common altered genetic background.

Second, shifting the entire ROA collection by starting the tracks at differing positions led to the conclusion that some variants are not seen due to uneven partitioning of the reads between the two ROAs covering the variant location. This typically occurs near the edge of a coverage falloff, so the details of where the falloff starts and where the ROAs end can matter. Combination of results across multiple ROA start locations using the same data falls prey to a multiple comparisons problem, so combining results from many starts to enhance recovery of true results may lead to a higher false discovery rate. When two of seventeen possible start positions (1 and 9) were used, we discovered some of the Sanger calls and several lower frequency variants, but also found increased discovery rates at very low frequencies. To counter this effect, the following rule was added: if a variant appears in only one ROA dual track set, then it must also be at a frequency above a second threshold set at a 50% sensitivity threshold, namely a 0.3% threshold. It was noted that some of the Sanger calls that are still missed fall prey to failure of verification—the variant is in a word with high frequency in one ROA but there is no matching half word in the overlapping ROA. As a result, adding yet another rule to the verification procedure was considered—words at a sufficiently high frequency are considered verified for the purpose of variant calling—but as they do not have a matching word they cannot be added as a custom allele fragment without considerable complication.

Although use of the ROA dictionary based variant calling method has been discussed in the context of ABI SOLiD 50 bp reads with mapping performed using BFAST using two tracks of ROAs with an ROA size of 34 with iterative allele variant enrichment of the reference sequence collection performed using original reference sequence backbone splicing, the technology is not constrained to work exclusively in this setting.

### Example 2

### Ultradeep Analysis of Tumor Heterogeneity, Kataegis, and Immunoglobulin Somatic Hypermutation

Cancer has long been considered a monoclonal process. Recent studies show that ongoing mutagenesis generates subclonal populations whose numbers wax and wane depending on the variant's relative evolutionary fitness. (Campbell et al., 2008, Proc. Nat. Acad. Sci. USA 105:13081-13086; Campbell et al., 2010, Nature 467:1109-1113; Gerlinger et al., 2010, British J. of Cancer 103:1139-1143; Marusyk et al., 2010, Biochimica et Biophysica Acta (BBA)—Reviews on Cancer 1805:105-117; Yachida et al., 2010, Nature 467:1114-1117) Tumor subpopulations possessing driver mutations conferring a selective advantage are the proposed source of tumor progression and acquired chemo-resistance. (Hunter et al. 2006, Cancer Res 66:3987-3991; Yip et al. 2009, Clinical cancer research: an official journal of the American Association for Cancer Research 15:4622-4629; Campbell et al. 2010, Nature 467:1109-1113; Diaz Jr et al. 2012 Nature 486:537-540, Ding et al. 2012, Nature 481:506-510; Gerlinger et al. 2012, British Journal of Cancer 103:1139-1143; Walter et al. 2012, New England Journal of Medicine 366:1090-1098). In addition to rare driver mutations of obvious importance, there are numerous passenger mutations of uncertain clinical significance but which can serve as an indicator of ongoing genetic stress within the tumor that gives rise to intra-tumoral genetic heterogeneity (Campbell et al. 2008, Proc. Nat. Acad. Sci. USA 105:13081-13086; Nik-Zainal et al. 2012b, Cell 149:994-1007; Walter et al. 2012, New England Journal of Medicine 366:1090-1098; Bea et al. 2013, Proc Natl Acad Sci USA 110:18250-18255). Several studies have suggested that the level of tumor heterogeneity itself may serve as a prognostic indicator (Maley et al. 2006, Nature genetics 38:468-473; Park et al. 2010, The Journal of Clinical Investigation 120:636-644; Mroz et al. 2013, Cancer 119:3034-3042). Thus, sequencing and analysis methods designed to identify and characterize tumor diversity may provide a relative measure of the mutagenic stress and/or inadequacy of the DNA repair systems within a given tumor with the potential to inform clinical care.

Various lines of study have focused on identifying the process(es) generating the observed intra-tumoral genetic diversity. Whole genome sequencing studies in breast cancer have identified a novel mutation pattern called kataegis, characterized as patches of extremely high mutation levels over relatively short stretches of the genome (Nik-Zainal et al. 2012a, Cell 149:994-1007; Burns et al. 2013b, Nat Genet 45:977-983). Concurrent studies identified APOBEC3, one in a family of cytidine deaminases, as the source of this ongoing mutagenesis (Burns et al. 2013a, Nature 494:366-370; Burns et al. 2013b, Nat Genet 45:977-983). Additionally, a recently published meta-analysis of exome sequencing studies found the APOBEC3 signature mutation pattern, along with kataegis, in a variety of cancers, suggesting APOBEC3 commonly mediates ongoing mutation in human tumors (Alexandrov et al. 2013, Nature 500:415-421; Burns et al. 2013b, Nat Genet 45:977-983).

Several aspects of kataegis are strikingly similar to the well characterized somatic hypermutation (SHM) of the immunoglobulin locus observed in B lymphocytes during an immune response. Both kataegis and SHM rely on cytidine deaminases acting at specific motifs to generate high density mutations. Activation Induced cytidine Deaminase (AID) is the APOBEC enzyme which initiates somatic mutations at specific motifs in the immunoglobulin genes (IGH, IGL and IGK) often altering 3-8% of bases within the ˜300-base antigen-binding regions of these genes (Golding et al. 1987, Genetics 115(1): 169-176; Rogozin and Kolchanov, 1992, Biochimica et Biophysica Acta (BBA)—Gene Structure and Expression 1171:11-18; Dorner et al. 1998, European Journal of Immunology 28:3384-3396; Foster et al. 1999, European Journal of Immunology 29:4011-4021; Rogozin and Diaz, 2004, The Journal of Immunology 172:3382-3384). While AID's physiologic function is to modify the immunoglobulin genes encoding antibodies via SHM, off target regions are also mutated by AID in a process termed aberrant somatic hypermutation (aSHM), a common observation in B cell tumors arising from germinal centers of lymph nodes, such as follicular lymphoma (FL) and diffuse large B cell lymphoma (Shen and Storb 1998, Science v280 (n5370): p 1750 (1753); Pasqualucci et al. 2000, Cancer Research 60:5644-5648; Pasqualucci et al. 2001, Nature 412:341-346; Liso et al. 2006, Blood 108:1013-1020; Rossi et al. 2006, Haematologica 91:1405-1409; Halldórsdóttir et al. 2008, Leukemia Research 32:1015-1021; Capello et al. 2011, British Journal of Haematology 152:777-780; Pasqualucci et al. 2011, Nature 471:189-195). These similarities in mutational patterns between SHM, aSHM, and kataegis suggest that a method designed for the identification and quantification of tumor subpopulations in B cell lymphomas could be well suited for analysis of kataegis in other cancers.

Tumor heterogeneity has recently been acknowledged as a particularly vexing problem in the design of cancer therapies. Among human tumors, follicular lymphoma is perhaps the archetype of neoplastic evolution, wherein a patient with a substantial disease burden but long stable clinical state, experiences a sudden and cataclysmic transformation of disease (Bernstein and Burack, 2009, ASH Education Program Book 2009:532-541). The goal of this project is to develop an analytical pipeline for PCR based targeted resequencing data that would identify, quantify, and define the relationships among subclonal populations within FL tumors approaching a 0.001 frequency. The advantages to using follicular lymphoma for development of an approach to measure tumor heterogeneity include, first and foremost, a positive control for genetic heterogeneity in the form of the uniquely rearranged IGH loci, a tumor-specific biomarker known to be subjected to ongoing SHM (Bahler et al. 1991, Blood 78:1561-1568; Zelenetz et al. 1992, J Exp Med 176:1137-1148; Zhu et al. 1994, Br J Haematol 86:505-512; Ottensmeier et al. 1998, Blood 91:4292-4299). Second, the AID-mediated mutagenic process responsible for SHM is well characterized with regard to sequence motif and substrate specificity, providing a mechanism to evaluate the validity of SNV calls, especially those at low frequencies. Third, there are known genes outside the IGH loci that can be subject to AID-mediated aSHM, providing selected regions with a high likelihood of significant mutational events for our targeted resequencing approach.

The color-based SOLiD platform was selected for this study because of the ability to apply color call correction, resulting in an extremely low platform error rate (Liu et al. 2012). BFAST 0.7.0a [http://bfast.sourceforge.net] was used as our primary color-space mapping program because it is specifically designed for discovery of genetic variants, incorporating a high number of masking indices to enhance read alignment along with a high tolerance for isolated single base changes (Homer et al. 2009a, PLoS ONE 4 (11): e7767; Homer et al. 2009b, BMC Bioinformatics 10: 175). This design incorporates sampling of sufficient numbers of cells (˜40,000 cells) and obtaining 30-50K deep raw read coverage to enable detection of a rare allele occurring at 0.1% with 30-50-fold coverage. In addition to identifying and quantifying SNVs on an individual location basis to estimate mutation rate, a process was developed that maintains allele-specific information for a better estimation of tumor evolution and heterogeneity. During the development of this analytical process, a high level of data loss due to failure to map reads derived from regions of aSHM/kataegis was observed, resulting in decreased sensitivity, which this approach addresses. Described herein is a coordinated mapping and analysis pipeline for SNV analysis in regions of high mutation which is call “deep drilling with iterative mapping” (DDiMAP). The schematic overview of this analytical pipeline follows the flowchart of FIG. 3. The key points for DDiMAP as used in this Example include partitioning of reference sequence into the computational units called Regions of Analysis (ROAs), with mapped reads assigned to one and only one ROA based on alignment information within BAM files. On a ROA basis, putative SNVs are maintained within sequence string context, forming unique ‘words’ for future consideration, and this set of words with associated frequency statistics is collected into a ROA dictionary, based on frequency thresholds. Retained words are partially assembled with sequences from overlapping ROAs in a statistical cross-validation selection process. These partially assembled sequences containing putative SNVs above a set threshold are used as additional reference sequences for remapping of reads, a process that is repeated until no new putative SNVs above a coverage dependent threshold are observed. Following convergence, data from all ROAs are tallied into site specific SNV calls while maintaining the dictionary-based sequences and statistics for additional uses.

DDiMAP is designed to sample, map, and detect rare variants using short reads from genomic regions containing mutation densities up to 33% variation. The approach identifies 80% of mappable tumor subpopulations occurring as infrequently as 0.4% in the specimen and >99% occurring at 1%. DDiMAP maintains subclonal specific sequences throughout the entire pipeline that can be subsequently used in phylogenetic analysis to describe tumor evolution, allowing a richer characterization of tumor subpopulation dynamics using a single measure of genomic variation.

### Methods

DDiMAP is designed to interrogate a relatively small region of the genome at a very high level of sequencing coverage to identify and quantify genetic subpopulations. The software developed for the analysis step of the pipeline (FIG. 3) can accept output from any alignment process that generates sorted BAM files, and it was found that the sequential use of multiple mapping algorithms with different design objectives can result in a more complete representation of sequence variation patterns. As stated previously, the primary components of DDiMAP analysis include: 1) dividing the reference sequence into units (ROAs) and uniquely assigning mapped reads to these ROAs; 2) for each ROA, generating the collection (dictionary) of unique read sequences (words) along with associated frequency statistics for both threshold and cross validation filtering to remove false SNV calls; 3) using partial assembly of high confidence SNV calls to generate additional alternate reference sequence fragments for iterative remapping, repeating the process until no novel high confidence SNVs above specific thresholds are found; and 4) compiling dictionaries representing ROAs covering individual reference locations for determination of final SNV calls.

### Generating Computational Units: Regions of Analysis (ROA)

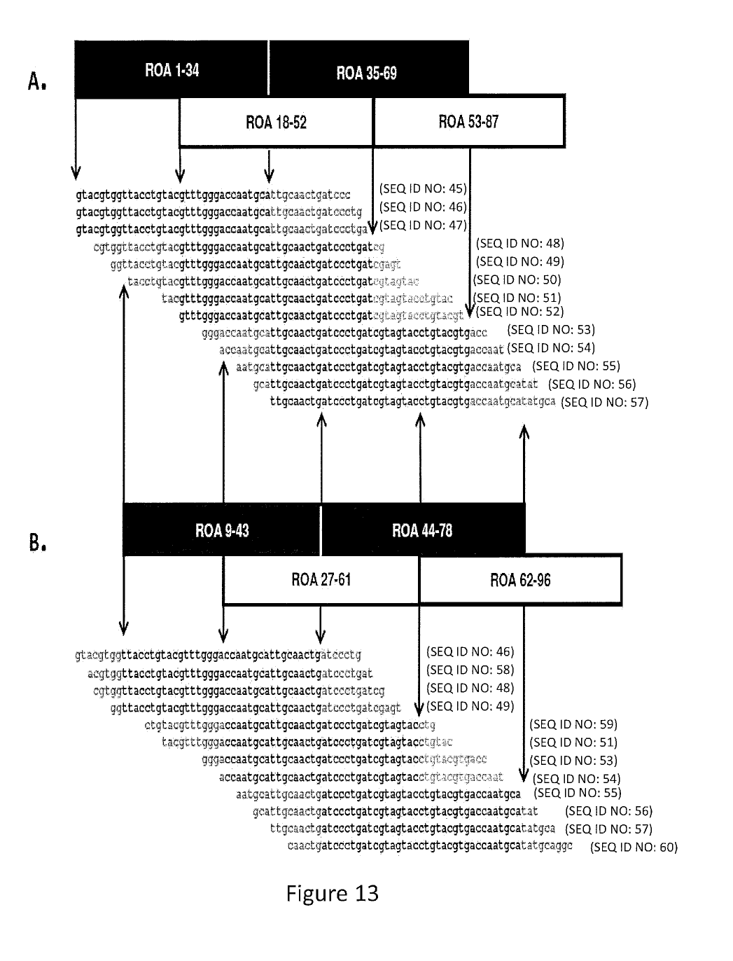

Regions of analysis are obtained by partitioning a reference sequence into two tracks of overlapping segments, generated by choosing an analysis start location on the reference sequence, selecting an ROA overlap length, and defining a ‘collection of ROAs’ as two tracks of abutting segments of the reference sequence that are each twice the length of the overlap length, with one track starting at the chosen start position and the other track offset by the overlap length. (FIG. 13). The mapped read start position and CIGAR string determine which bases in the reference sequence, and thereby which ROA(s), are covered by the read. If more than one ROA is covered, we assign the read to the ROA closest to the start of the read according to its read direction, with a tie broken by using the ROA closest to the start of the reference sequence. The read is trimmed to fit the ROA or, if the read is sufficiently long to cover multiple abutting and non-overlapping ROAs, it may be split amongst them and trimmed Reads containing indels are handled by eliminating inserted sections that do not correspond to bases in the reference sequence and by inserting missing data symbols (-) in deleted segments. Considerations related to selection of ROA size can be found in both the discussion and supplemental information.

For this Example, a ‘word’ is defined as the nucleotide sequence that spans an ROA from a read segment. For this Example, a ‘dictionary’ is defined as the collection of unique words belonging to a particular ROA. Statistics collected for each word in a dictionary include the number of occurrences in each read direction and number of letter differences from the reference sequence. In this way, the thousands of reads that are assigned to any given ROA are reduced to a dictionary of words and their associated strand tallies, generating a histogram for each ROA that represents all unique sequences observed.

### Multistep Filtering Process: Threshold Filtering

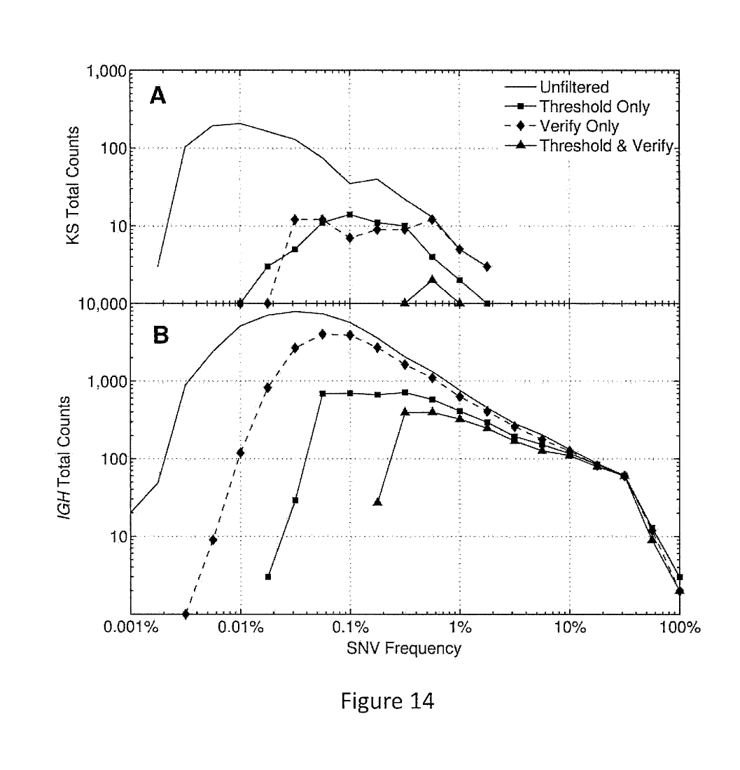

The first step eliminates false SNV calls arising from random instrumental error based on a minimum frequency threshold. Because each word is a sequence pattern covering multiple locations in a gene, words containing false SNV calls due to random instrumental noise are less likely to be repeated in multiple reads than words containing the true calls arising from actual genetic variation. It was found that a minimum threshold frequency filter requiring words to occur at least two times in each direction, as determined heuristically by analysis of invariant control, a pBluescript II KS fragment, was effective in eliminating many words that contain noise in relatively low coverage areas. In higher coverage areas (>2500×) it was found that the filter required a larger threshold which is proportional to coverage to maintain the same effectiveness (FIG. 14). This threshold can be set at a relatively high level (such as 1%) to provide more stringent filtering for generation of alternate reference fragments or at lower level (such as 750 ppm) for final SNV calls.

### Multistep Filtering Process: Cross Validation Through Partial Assembly

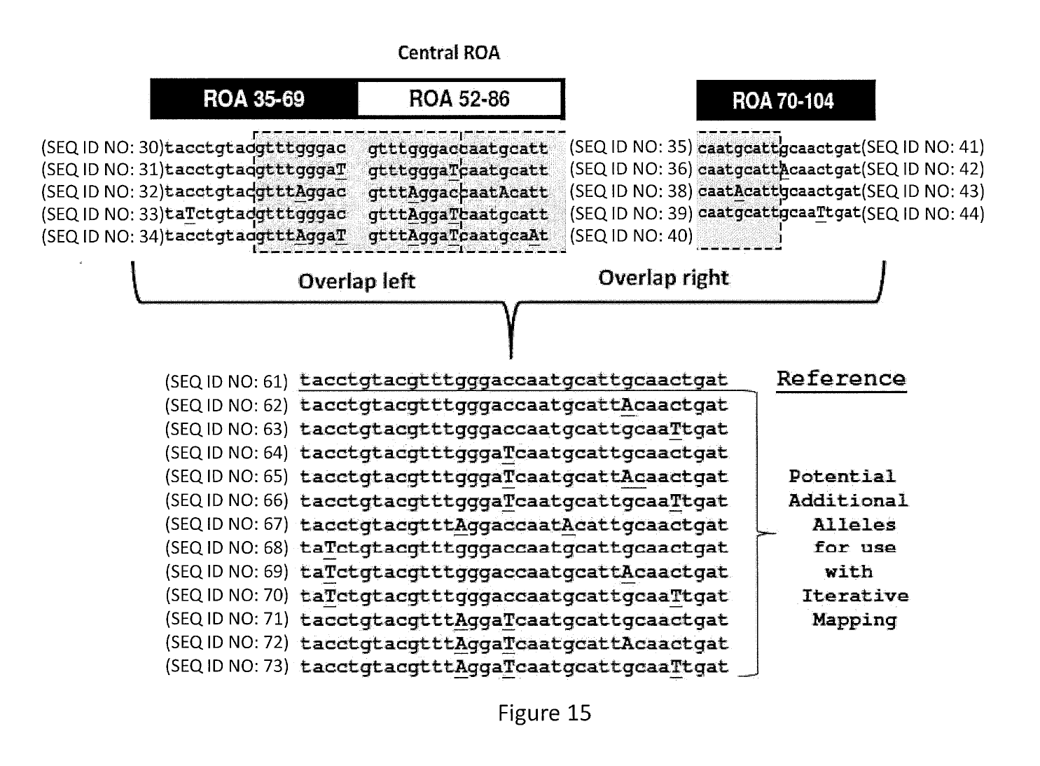

The second stage utilizes partial assembly of words from overlapping dictionaries to verify sequence patterns in a statistical cross-validation process. This stage leverages the unique assignment each read segment to a single ROA track which guarantees that sequence data from two overlapping ROAs within the same ROA collection come from independent sets of reads (FIG. 13). To perform the cross-validation, each unique word in an ROA dictionary is split, and the half words are compared to the corresponding half words from their overlapping ROAs: words that have matching half sequences from both overlapping ROAs are ‘verified’, words that only match on one side are ‘partially verified’, while words that have no match with either overlapping ROA are ‘non-verified’ (FIG. 15).

### Iterative Remapping

Alternate reference fragments are constructed from sequence and assembly information generated during the partial assembly step for cross-validation analysis (FIG. 15). For each ROA, words in its dictionary that are tagged as ‘verified’ are extended in both directions by assembling combinations of matching verifier words from overlapping ROA dictionaries. Words that are ‘partially verified’ are extended in their verified direction using matching verifier word(s) and in the other direction by appending reference sequence. Words that are ‘non-verified’ are extended in both directions using reference sequence. This partial sequence assembly process may be extended as needed to construct a sequence fragment that is sufficiently long to allow the alignment program to map reads to the central ROA containing the variant word(s). In this particular case with 50 base reads and ROA of 34 bases, generating alternate reference fragments of 68 base length is sufficient to allow mapping of all reads that can cover the central ROA. A stringent threshold filter setting (>1%) was used after forming the ROA dictionaries to limit introduction of false SNVs. Additional reference fragments are introduced into the reference sequence collection for the next mapping iteration by choosing all extended fragments built around ‘verified’ or ‘partially verified’ words and by choosing extended fragments built around ‘non-verified’ words only if the central word accounts for >10% of its ROA coverage. If needed, the process may be done for multiple ROA tracks differing in their start position to provide additional alternate reference fragments.

This process of generating additional reference fragments and mapping using the augmented reference sequence collection is repeated until no new SNVs are observed above the stringent threshold settings. For the data set, all sequences converged (generated no additional variants) within 4 rounds of mapping based on two ROA collections offset by half their overlap length (see below and FIG. 13). The final analysis is performed with a more permissive threshold setting in dictionary formation (750 ppm) to allow discovery of rarer SNVs in areas with higher variation, capitalizing on the enhanced mapping sensitivity provided by the augmented reference sequence collection.

### Compilation Across all ROA Dictionaries for Final SNV Calls

Coverage irregularities are common in massively parallel sequence data, and steep differences in coverage may lead to significant differences in the read distribution for one start position compared to another nearby position. When this distribution of reads across overlapping ROAs is highly one sided, a true variant may be eliminated by the two-stage filter solely due to a lack of coverage in one of the overlapping ROAs. One solution is to generate a second ROA collection with an offset start location, building ROA dictionaries from differing sets of reads and using differing portions of each read to form the dictionary (FIG. 13). It was found that identifying consensus SNV calls across ROA collections allowed detection of variants that were missed when using a single ROA partition. If more than one start position is to be considered, for computational efficiency and a high degree of parallelization, ROA dictionary collections for all possible start positions are formed in a single pass through the BAM file, from which an ROA dictionary collection for any number of start positions may be selected for analysis.

In this targeted resequencing study, it was found that it was not necessary to look at results from all possible ROA start positions to effectively enhance the sensitivity. For this data set, a dual start position analysis with an offset between the ROA collection start sites equal to half of the overlap length was sufficient to recover much of the lost sensitivity, by maintaining SNV calls that occur either above a set threshold frequency from an ROA collection or at any frequency when observed in both ROA collections. For each of the two ROA collections, the nucleotide data was tabulated at each position of the reference sequence from the words in the dictionaries according to their verification status and ROA start position and compute frequencies of each base at each location relative to the local coverage. These results are then used to identify discovered SNVs.

### SNV Calling Stage

The final stage calls SNVs by applying three simple rules: 1) the SNV is called if it is present in a verified word in both ROA collections, regardless of its frequency; 2) the SNV is called if it is present in a verified word in either ROA collection at a sufficiently high frequency (>0.3%); 3) the SNV is called if it is present at a much higher frequency (>10%) even if the word(s) containing the call are unverified.

Application of the first three stages eliminates >99.5% of SNV variants observed in reads on pBluescript II KS negative control (FIG. 14). The 4 remaining verified SNVs in KS each occurred at low frequency (<1.5%) and 3 were associated with an intersection of 2 homopolymeric runs, sequences known to be susceptible to polymerase generated errors. To eliminate such nonrandom errors, all identical SNVs were classified as shared variants that occur at the same approximate low frequency (˜1-3%) in any controls and FL specimens as probable library and/or polymerase generated sequence errors and these data were removed from further consideration. Using these criteria, 37 sites of apparent shared variation were identified out of 9186 non-IGH locations.

### DNA Preparation and Amplicon Production

The data used to develop this analytical pipeline was from a PCR based targeted re-sequencing of upstream noncoding regions of selected genes from follicular lymphoma (FL) specimens, a B cell tumor that has been shown to have ongoing AID activity through continued SHM within IGH (Bahler et al. 1991, Blood 78:1561-1568; Zelenetz et al. 1992, J Exp Med 176:1137-1148; Ottensmeier et al., 1998, Blood 91:4292-4299). Test specimens include lymph node biopsies from 12 FL tumors, 3 hyperplastic lymph nodes (HP) as a source of nonmalignant polyclonal B cells, all obtained as de-identified samples from the Human Hematological Malignancy Tissue Bank at URMC in accordance with institutional IRB protocols, and HEK 293 as a source of clonal non-lymphoid tissue.

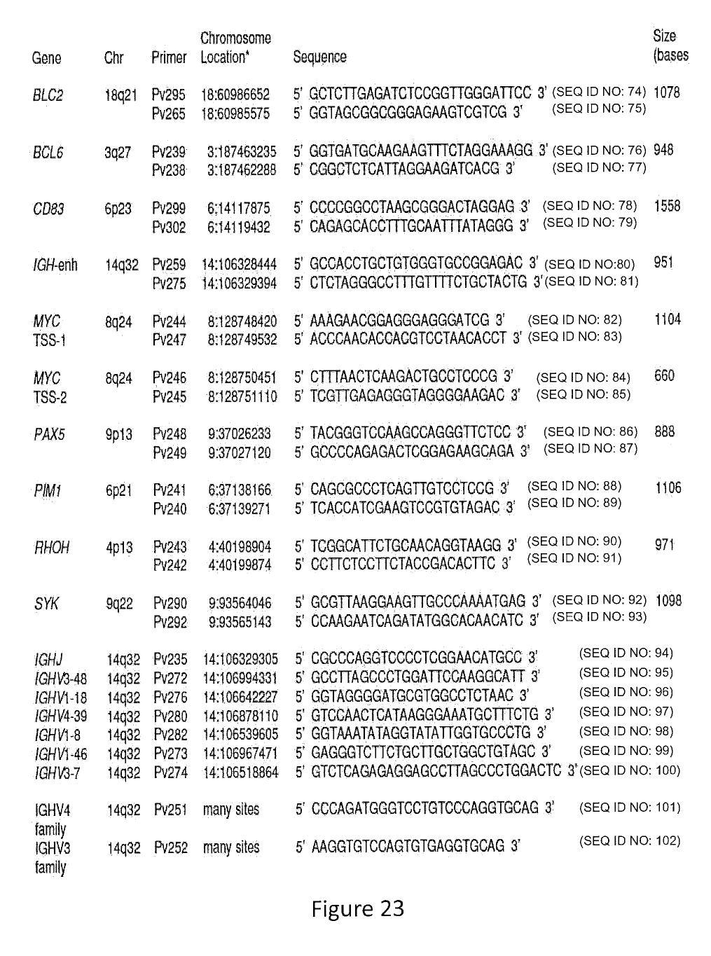

Genetic targets were selected for a variety of reasons, including published findings of aberrant SHM in DLBCL and FL in humans (proto-oncogenes BCL6, PIM1, PAX5, RHOH, and MYC (Pasqualucci et al., 2001, Nature 412:341-346; Halldörsdöttir et al., 2008, Leukemia research 32:1015-1021) and in DNA repair deficient mice (CD83 and SYK) (Liu et al., 2008, Nature 451:841-845). BCL2, a component of the hallmark t (14; 18) genetic lesion of FL, was included because of its high rate of expression, a critical requirement for aberrant SHM. Two IGH regions, the natural targets of SHM, were also studied, including an IGH intronic region (IGH-enh) common to all cells as well as the tumor specific rearranged IGH from the FL specimens. Reference sequences for mapping were obtained from GRCh37.p10 (accession GCF_{—}000001405.22) (www.ncbi,nlm.nih.gov), while the clonal IGH sequences from each FL specimens were obtained through Sanger sequencing of homo-duplexed, gel-purified PCR amplicons (FIG. 23).

### DNA Preparation

Single cell suspensions were prepared from lymph nodes and viably frozen by the Human Hematological Malignancy Tissue Bank at URMC without any cell selection. DNA was extracted from ˜5ê6 cells using the QIAamp DNA Mini Kit (Qiagen Inc., Valencia, Calif.) according to standard protocol and the concentration was estimated by spectrophotometry (NanoDrop, Wilmington, Del.).

### Amplicon Generation

The PCR was performed according to manufacturer instructions with Phusion® Hot Start High Fidelity DNA polymerase (NEB, Ipswich, Mass.) using HF buffer and 3% DMSO. Template amount (250 ng) was chosen to ensure sampling of sufficient cells (˜40,000) for statistically valid estimation of low frequency events, designed to be sufficient for identification of a 0.1% population at >95% probability in the absence of instrumental error. The reaction was cycled 35 times between 98° C. for 10 seconds, 66-72° C. for 15 seconds and 72° C. for 45 seconds, preceded by 3 minutes at 98° C., and followed by 5 minutes at 72° C. Stringent annealing temperatures were chosen to enhance primer specificity and limit off target binding. Amplicons were screened for correct size by electrophoresis on 0.7% agarose gels in TAE buffer (Invitrogen/Life Technologies, Grand Island, N.Y.), purified with QIAquick PCR Cleanup kit (Qiagen Inc.) and quantified by spectrophotometry (NanoDrop).

### IGH Identification

IGH was amplified from the FL specimens using the Biomed 2 IGH framework 2 primer set and JH consensus primers (van Dongen et al. 2003, Leukemia 17:2257-2317). Clonal IGH was identified by heteroduplex analysis of the PCR amplicons, followed by gel purification and sequencing of the homoduplexed band. The PCR reaction used 50 ng of genomic DNA as template with HotStarTaq (Qiagen) according to manufacturer directions. The reactions were cycled 35 times between 94° C. for 30 seconds, 61° C. for 30 seconds and 72° C. for 90 seconds, preceded by 5 minutes at 94° C., and followed by 5 minutes at 72° C. Heteroduplex analysis was performed by heating the amplicons for 5 minutes at 98° C., followed by rapid cooling to 4° C. for 2 hours. Homoduplexed DNA was identified using a 2% NuSieve 3:1 agarose gel (Lonza Basel, Switzerland), purified using QiaexII gel purification kit (Qiagen) according to manufacturer directions and sequenced. Clonal IGHV gene used for each FL specimen was identified using IgBLAST (http://www.ncbi.nlm.nih.gov/igblast/) and the final amplicon for SOLiD sequencing was generated using gene-specific IGHV primer paired with a common IGHJ-region primer (Pv235) located downstream of IGHJ6, using common PCR parameters as described for amplicon generation above.

pBluescript II KS Negative Control (Agilent Technologies, Inc., Santa Clara, Calif.)

A purified plasmid preparation of pBluescript II KS was digested with Pvul (NEB) according to manufacturer protocol. The 1045 bp fragment was isolated using a 0.7% agarose gel (Invitrogen/Life Technologies, Grand Island, N.Y.), purified with QIAquick Gel Extraction kit and the concentration was estimated by spectrophotometry (NanoDrop).

### Library Preparation and SOLiD Sequencing

For each specimen, the amplicons were mixed in equimolar ratios, FL specimens were spiked with 0.1 equimolar pBluescript II KS fragment, and 2 μg of mixed amplicons were submitted to the Functional Genomics Center at the University of Rochester for library preparation and SOLiD 4 sequencing. As part of the library preparation, the samples were concatenated, fragmented with the Covaris S2, and appropriately barcoded according to ABI standard protocols

### Supplemental IGH Specific Considerations:

The IG loci are extremely difficult to analyze by NGS due the highly variable nature of this region and thus these represent a severe test for mapping algorithms. While this variation from germline is often profound in physiologically normal B-cells, the variation is even more exaggerated in FL. In the early steps of normal B cell maturation, non-templated nucleotides are added within the rearranged IGH genes, generating regions for which no reference sequences are available. In later, transient stage of B cell maturation, AID further mutates the IGH gene, with the potential to generate a large amount of genetic diversity at IGHV, even within a single B-cell clone. In FL, the B cells appear to be “trapped” in this stage of maturation in which AID activity is high, and the result is even greater mutation of the locus. For these reasons, the Sanger sequence of clonal IGH amplicons was used from each FL specimen for mapping purposes.

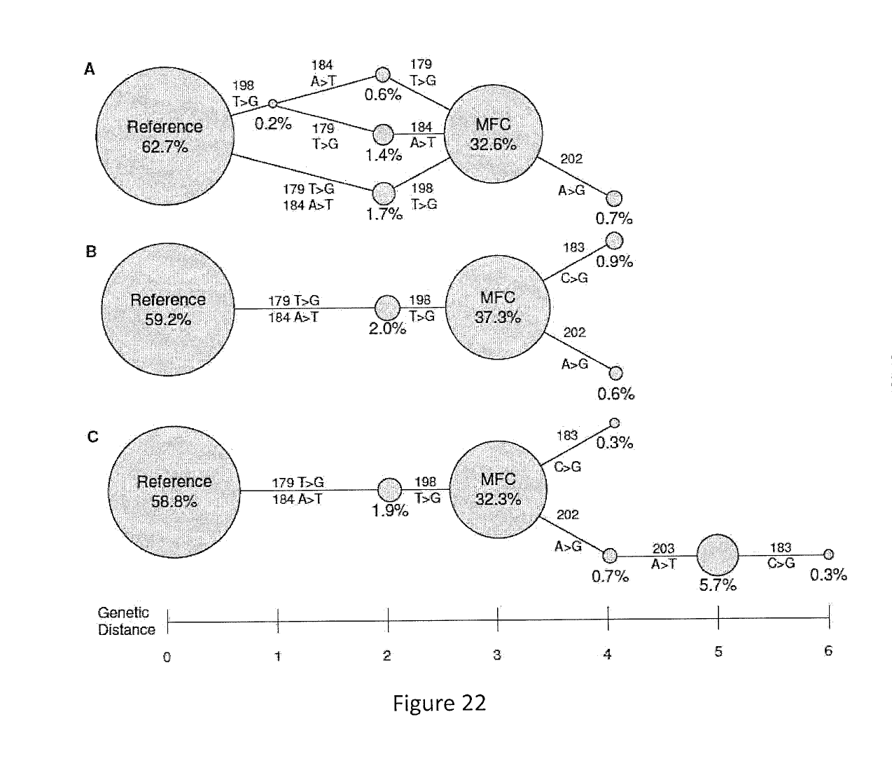

This use of Sanger sequence for the individual IGH references interfered with the ability to analyze the IGH data for AID-specific mutation patterns, as the SNV calls made against the Sanger sequence reflect changes away from the mutated reference, not germline sequence. During the SHM process, AID damage and repair often destroys the AID motif Additionally, mutations can generate new AID motif sites depending on their neighboring sequences. These two types of changes confound the ability to link observed mutations to AID motifs. While one could examine the germline sequences to identify motif locations, one can never be sure of the mutation-generated AID motifs that were formed and subsequently broken during the cells prolonged exposure to AID. An example of motif generation is shown in FIG. 22. The BCL2 sequence from 128 in FIG. 22C shows the generation of a 183 C>G mutation arising once as a terminal descendant off the most frequent clone (MFC), and again as a great-grandchild of the MFC, also at 0.3%. Based on germline sequence, this location is not an AID motif. However, one of the earliest mutations from the reference sequence and ancestral to the MFC is 184 A>T, which converts 183 C into an AID motif, generating the higher probability of subsequent mutation occurring at that location.

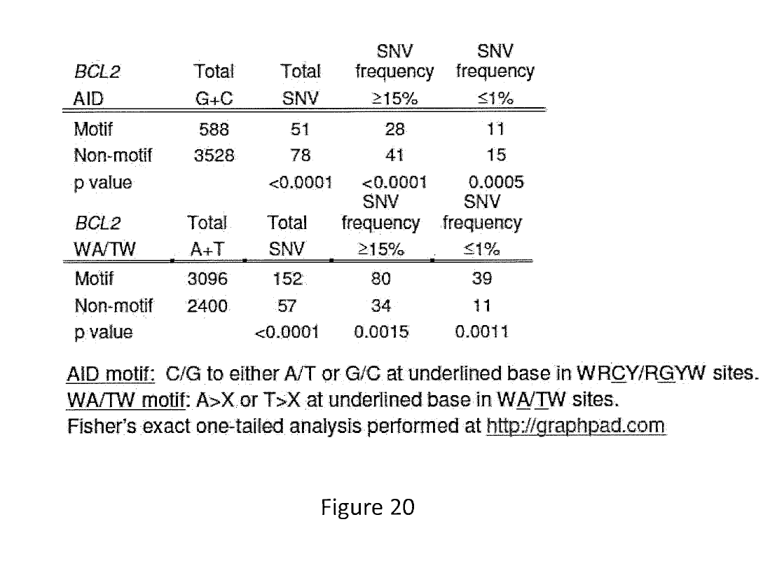

The BCL2 region is subject to a high rate of aSHM in FL cases, responsible for well over 50% of the SNV calls outside the IGH areas. This resulted in a substantial number of SNVs both above 15% and below 1% frequency, allowing the use BLC2 as an appropriate target for mutation pattern analysis. In this evaluation of mutation patterns in BCL2, it was counted as matching the AID motif only those SNVs that occurred at the motif location and generated the dominant base change most often observed, a stringent interpretation of the data (FIG. 20). Even under those constraints, both the high and extremely low frequency SNV calls showed a significant AID motif bias (p≦0.0015).

### Supplemental Considerations for Mapping

Mapping of the Solid color space data to reference genome sequence data was done using the BFAST 0.7.0a [http://bfast.sourceforge.net] (Homer et al. 2009a, PLoS ONE 4:e7767; Homer et al. 2009b, BMC bioinformatics 10:175) and SHRiMP 2.2.3 [http://compbio.cs.toronto.edu/shrimp] (Rumble et al. 2009, PLoS ONE 5; David et al. 2011, Bioinformatics 27(7): 1011-1012) software. These programs use masking techniques to first determine candidate alignment locations for each read using various patterned subsequences of read and reference genome color space data followed by use of color space aware Smith Waterman methods to align calls to the reference genome including consideration of indels. Both programs correct isolated color inconsistencies between read data and reference genome data that would otherwise cause wholesale differences in nucleotide space. In BFAST, the latter stage is specifically designed to respect color space patterns associated with isolated single nucleotide variants, which appear as context dependent consecutive color difference pairs regardless of the number of locations in which they occur in the read, whereas SHRiMP uses a total variability cutoff that can handle reads with adjacent base differences but eliminates reads with too much variation. In the final step of BFAST analysis, one can either insist on retaining any colors that were in the patterned sub-sequence match that led to consideration of an alignment or may allow unconstrained changes; the latter option was chosen. Other than that choice, the settings used for BFAST followed the standard suggested settings (Homer et al. 2009a, PLoS ONE 4:e7767; Homer et al. 2009b, BMC bioinformatics 10:175). For these samples, typically ˜80% of the reads are successfully mapped to the reference genome using these settings for BFAST. The settings used for SHRiMP were the default settings and it typically mapped ˜60% of the reads using its more conservative settings.

Preparation of genetic material for sequencing introduces a number of in-vitro recombinants as it includes concatenation of PCR amplicons, a blunt end ligation of the amplified genetic material before disruption by cavitation to produce fragments suitable for sequencing. Corresponding recombinant sequences were added, derived primarily from primers, to the reference sequence pool by taking the first and last 49 bases from each target region, concatenating them as appropriate into 98 bp sequences included in the reference sequence used for mapping. These served as sinks for 50 bp reads generated from these artificial junctions that would align poorly or be misinterpreted if aligned.

### Color Call Error Rate and Threshold Setting to Avoid False Discovery

BFAST provides data in its BAM file that includes the color edits it made in order to produce an alignment. Inspection of these changes leads to the conclusion that for the data, ˜5% of the color calls in mapped reads are replaced with colors from the reference to which the read is mapped in order to produce a consistent nucleotide interpretation of the alignment.

If these truly represent instrumental noise and occur completely randomly, in a sequence of length 50, over 90% of the sequences would contain one or more color errors, so clearly color correction is a necessary step. The bulk of these errors would be isolated, but ˜0.5% would appear as two consecutive color differences from the reference and of these, one in four would be consistent with a single nucleotide variant, leading to a ˜0.13% rate of invalid single calls. Such invalid calls are further split into three groups, one for each alternate nucleotide, so that any particular alternate would appear at a ˜0.04% rate or ˜400 ppm on average. In such a random process, there will be some erroneous calls that occur more or less frequently, so use of the result of this value as a threshold would eliminate only ˜50% of the false calls due to instrumental error. It is interesting that the threshold was determined empirically to eliminate false positive calls in the negative control, 750 ppm, corresponds to a value well above 400 ppm.

### Influence of Color Correction Errors

A few interesting consequences of error correction in color-based space were occasionally observed during dendrogram analysis, allowing one to identify two scenarios where improper interpretations were made. The first case arises with a read covering an isolated SNV at a given location, when one of the two color changes necessary for the direct interpretation of the SNV is an erroneous color call. When only the original reference sequence is available, color-sensitive mappers will always revert to the reference sequence, leading to a false negative SNV rate dependent on the error rate of the color call process. This phenomenon is likely to be the source of the artificially low frequency estimates for the homozygous and heterozygous SNPs as well as a general bias toward underestimation of other relatively high frequency SNVs seen in the first mapping iteration.

In the iterative case, where both the original and alternate reference sequences are available, four of six possible miscalls will not match the original reference either and are properly corrected to match the alternate, and even in the two cases where a single miscall matches the original, it will be corrected to the alternate sequence half the time. Thus, by having the alternate sequence available through iterative remapping, this false negative SNV rate will be dramatically reduced, providing increased precision in frequency estimates. In cases where the descendant population represented by an alternate sequence is sufficiently large and contains multiple changes from the original reference sequence within an ROA, reversion of a single change to the reference sequence due to this false negative process may result in multiple false ancestor words with one fewer change that can complicate a dendrogram (FIG. 22A). This typically does not cause an SNV call to be missed, as it merely leads to a small downward bias in its frequency.

The second correction-based false interpretation scenario occurs in selected cases with three adjacent mutations or two mutations flanking a non-mutated base. In these rare cases, dependent on the bases in the first and third positions, it can be more economical for the mapper Smith-Waterman analysis to change the middle base rather than tolerate the multiple changes to color calls necessary to generate the true base calls. The upshot of this is that two or three SNVs are dropped and a false SNV is substituted in their place. The logic in BFAST generally changes the color calls in this situation to produce the incorrect center base call. The logic in SHRiMP can make a correct triplet call in this situation although it also can make the incorrect call as it tries to balance base differences from the reference sequence against color edits in the data, especially when there are already several other differences from the reference sequence in a highly mutated area.

In an iterative scenario, if SHRiMP provides a correct triplet call for enough reads that the triplet is incorporated into an alternate reference fragment, both programs will choose that interpretation when presented with a read containing the matching color sequence. However, if a BFAST iteration precedes the first SHRiMP iteration, alternate allele generation will provide a template containing only the incorrect call which either algorithm will latch onto for its interpretation. On first blush, it would therefore seem prudent to do a SHRiMP first iterative scheme. However, in cases where the number of mutations in a region causes SHRiMP to choose the incorrect interpretation, no ordering of algorithms will produce the correct result. It has not escaped Applicants' attention that this Catch-22 may be resolved by looking for patterns in the color edits as well as base calls when analyzing the mapping data and overriding the decision consistently made by the mapper on a read-by-read basis when consensus evidence from multiple reads is combined when creating alternate alleles.

### Results

DDiMAP increases the sensitivity of SNV calls while maintaining specificity through two synergistic processes: a sequence cross validation procedure to eliminate noise inherent in massively parallel sequencing and modifications to the mapping component designed to increase the accuracy of aligning reads from highly mutated regions of the genome, resulting in enhanced data capture. Key to attaining both goals is retention of the putative SNV information as a read based sequence string throughout the analytic pipeline.

### ROA Partitioning and SNV Determination

Prior to mapping of the read data, the reference sequence is partitioned into discrete overlapping computational units called Regions of Analysis (ROA). Each mapped read is uniquely assigned into a reference sequence ROA (FIG. 13). Within each ROA every unique sequence variation observed is maintained as a sequence string (‘word’). The set of unique words from each ROA forms a ‘dictionary’. Once a complete ROA collection of dictionaries are formed, filters are applied to classify the words.

The primary filters include a threshold based on minimum observed frequency for each word in a bidirectional manner and a cross-validation of the actual sequence through partial assembly of words from independent sets of reads. The two-stage filtering process used in DDiMAP removes the low frequency SNV calls typically associated with process ‘noise’ while retaining the higher frequency SNV calls typically associated with true SNVs (FIG. 14). Each filter process individually removes >90% from the negative control (pBluescript II KS fragment) but together remove >99.5% of SNV calls while retaining the vast majority of positive control (IGH) SNV calls between 1 and 10% and virtually all at >10% frequency.

Iterative Remapping Enhances Read Capture from Regions with Dense Mutations.

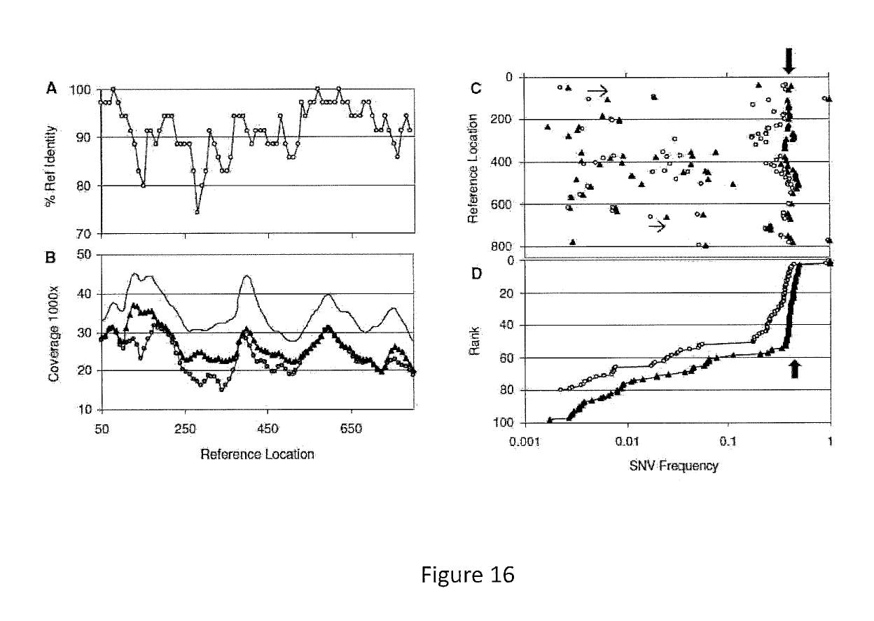

Preliminary analyses of the data found numerous SNVs identified by Sanger sequencing that were not identified by NGS. These false negatives were generally associated with the greatest densities of SNVs and coincided with regions that showed lower coverage, reflecting a failure to map highly mutated reads (FIG. 16A, 16B). Enriching the pool of reference sequences by including sequence patterns associated with previously identified high confidence mutation calls, followed by remapping, resulted in improved mapping efficiency and enhanced discovery of additional variant sequences (FIG. 16C). In regions with the greatest deviation from reference sequence (for example locations 250-300 in FIG. 16B) iteration raised coverage by ˜50%.

To iteratively augment the reference sequences used for mapping, additional reference fragments were constructed from reads with SNVs discovered and validated through partial sequence assembly (FIG. 15). This process of generating additional reference sequences and remapping using this augmented collection of reference sequences is repeated until no new words above set thresholds are observed. While this iterative process has the potential for positive feedback, generating ever increasing numbers of additional reference fragments from the mapping of error filled reads, this can be controlled: the analysis of all 12 tumor specimens converged within 4 rounds of iteration. In fact, the absolute numbers of alternate reference fragments often decreased as more complete mapping was achieved, due to partial mutation patterns coalescing into the actual sequence present in the genomic DNA.

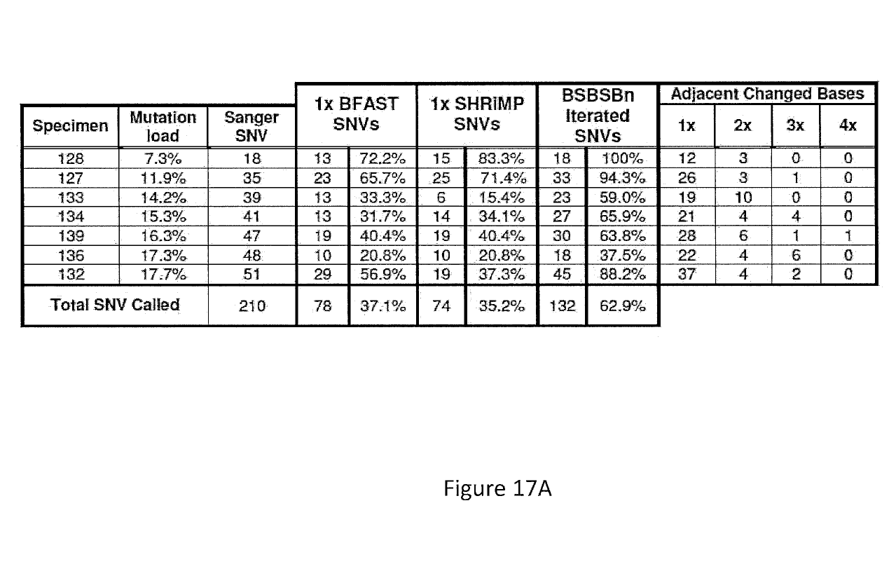

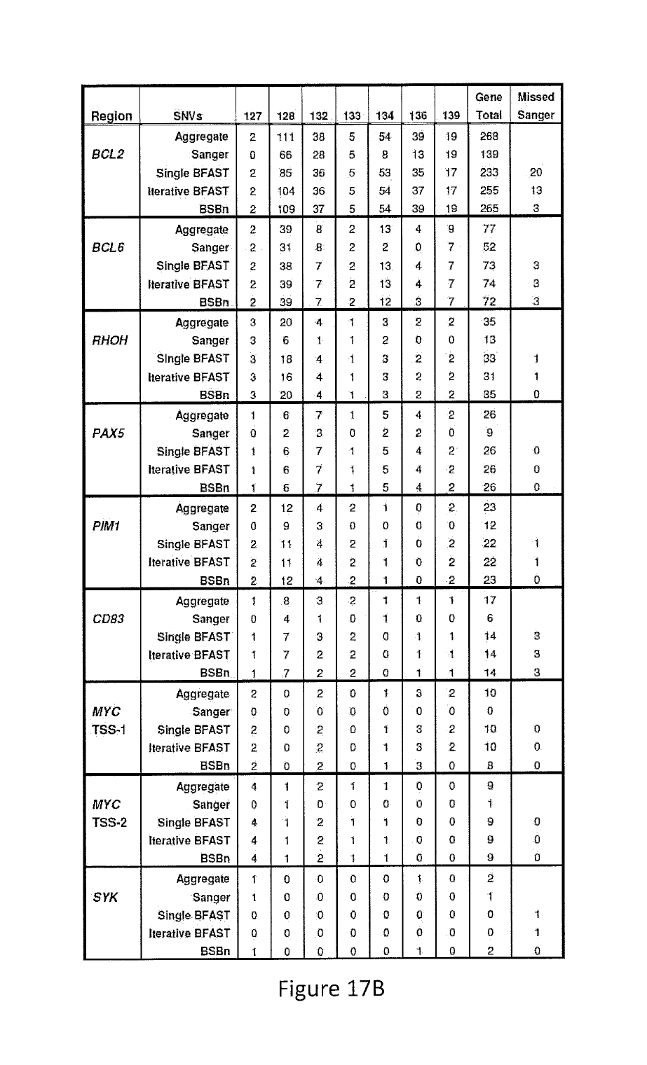

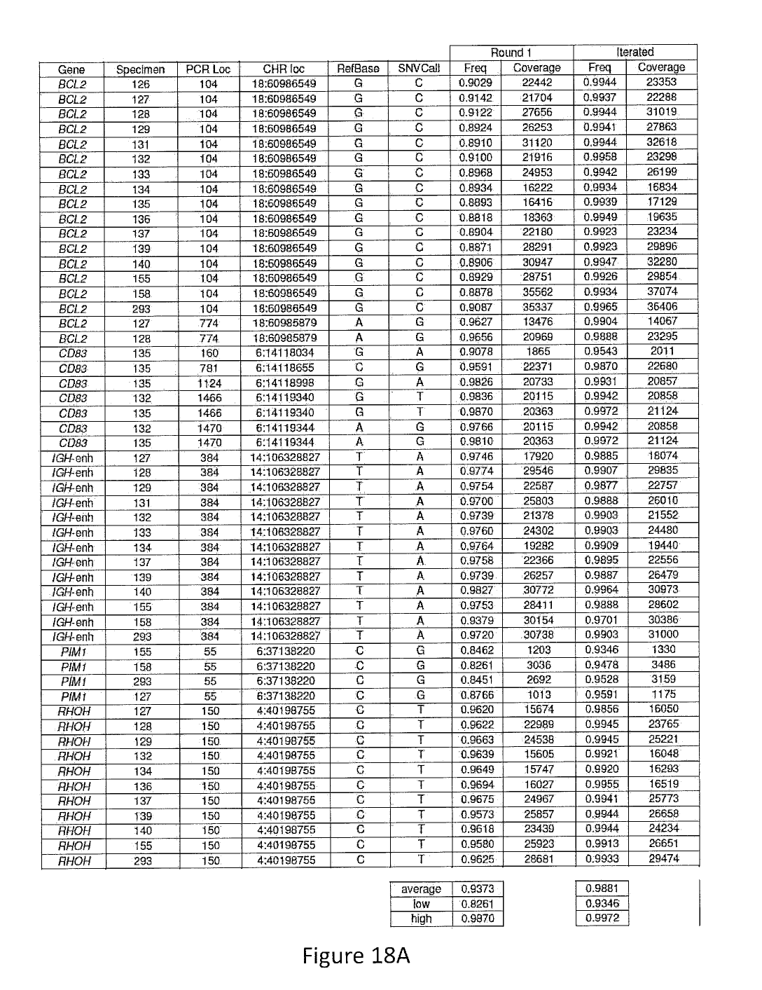

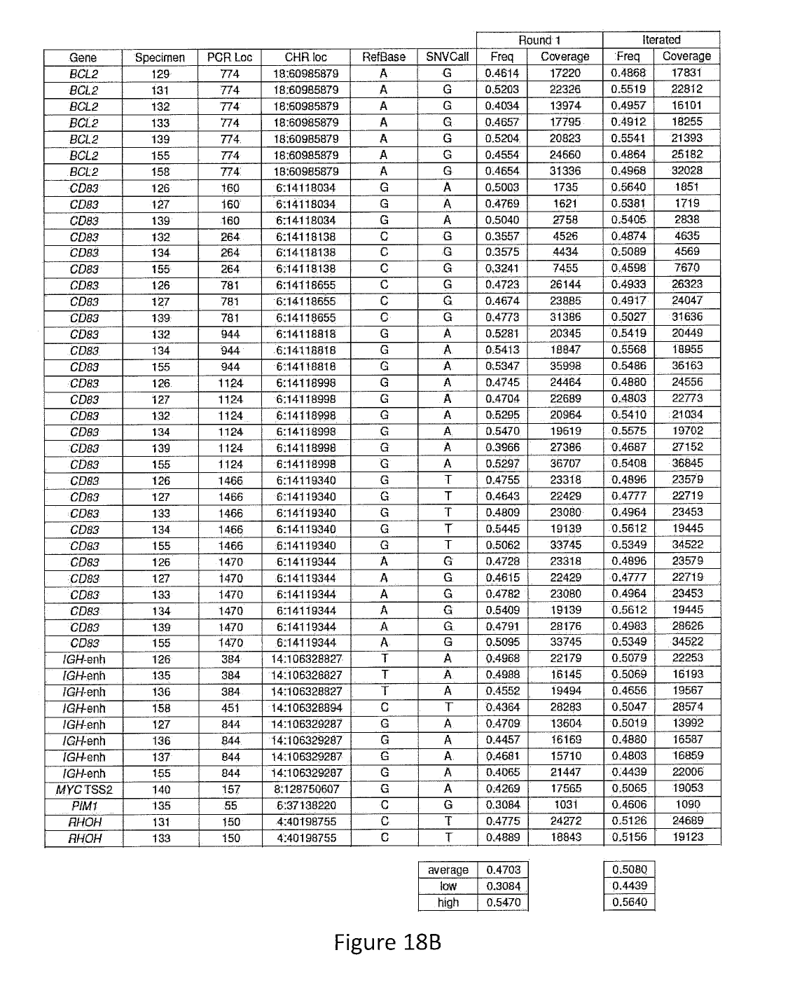

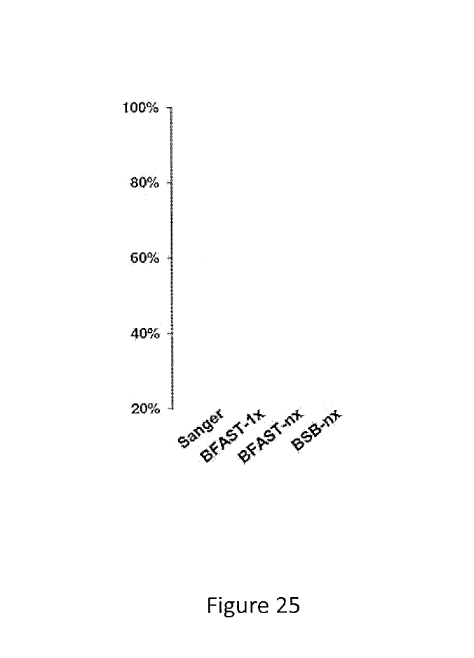

There are two major advantages to iterative remapping. First, iteration allowed identification of additional SNVs in genetic regions with locally high densities of mutations (See IGH data in FIG. 17A and BCL2 data for patient 128 in FIG. 17B and FIG. 25). Second, iteration significantly improved both the accuracy and precision of the SNV frequencies thus clarifying the nature of subpopulations within the tumor (FIG. 16D). An internal control of 54 homozygous SNPs showed frequency results averaging 93.7% (range 82.6-98.7%) on first mapping increasing to 98.8% (range 93.5-99.7%) following iteration to convergence. Similar improvements were observed in 49 heterozygous SNP frequency results averaging 47.0% (range 30.8-54.7%) initially and rising to 50.8% (range 44.4-56.4%) following iteration (both at p<0.0001, paired t-test, graphpad.com—see FIG. 18). These results suggest that identification of subclonal populations by frequency comparisons are also more accurate and precise following iteration. For example, iteration dramatically narrows the range of frequencies associated with the bulk of SNVs discovered in the BCL2 gene of a single patient (vertical arrow; FIG. 16D), strongly suggesting that all these SNVs are simultaneously present in the founder population. Without iteration, the range of frequencies could suggest that subsets of these SNVs were present in distinct subpopulations, not necessarily shared by the bulk of tumor cells.

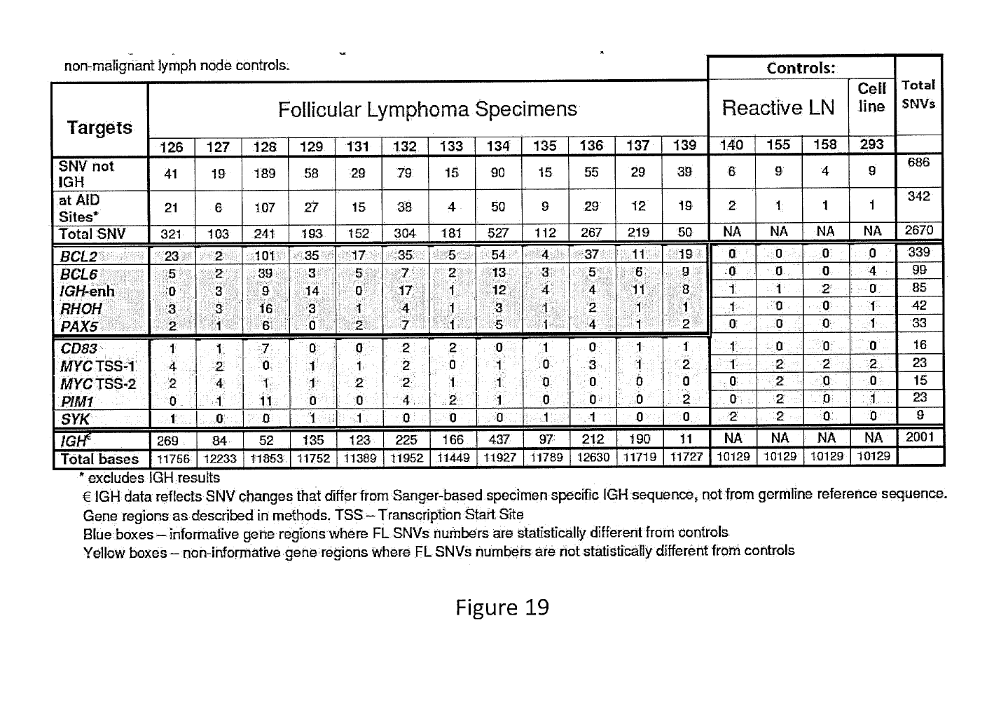

Several lines of evidence indicate that DDiMAP has a low false discovery rate. First, it was validated by Sanger sequencing >92% of SNV calls identified and quantified by DDiMAP as occurring with an allele frequency ≧15% (the approximate limit of detection of Sanger sequencing). Second, DDiMAP did not generate significant numbers of false positive SNV calls, even at low frequencies, as evidenced by the complete lack of SNV calls in some regions while other regions from the same specimen show mutation rates >10% (FIG. 19), demonstrating the ability of the filtering algorithms to remove low level process noise while retaining true signal. Third, analysis of the tumor specific SNVs in BCL2 regions from FL specimens, at both high (≧15%) and extremely low allele burden (≦1%) frequencies identified a consistent and highly significant bias towards the AID mutation patterns (FIG. 20. WRCY motif p≦0.0005, WA/TW motif p≦0.0015 by one-tailed Fisher's exact test performed at http://graphpad.com), strongly indicating that the called SNVs at both high and low frequencies are due to aSHM and are not a computational artifact. One can calculate a maximum false discovery rate of <3%, based on the highly conservative assumption that all non-Sanger level SNVs from controls, and all calls from FL specimens from non-informative genes are false positive calls, and that all SNV calls from IGH and informative genes from FL specimens are a mix of true and false positive calls (Table 1).

### Influence of Mapping Program.

The results are dependent on the use of two specific color-space mapping programs, BFAST and SHRiMP 2.2.3 [http://compbio.cs.toronto.edu/shrimp] (Rumble et al. 2009, PLoS ONE 5; David et al. 2011, Bioinformatics 27(7): 1011-1012). It was found that using two mapping programs together, each having algorithms that give them differing sensitivities to distinct patterns of SNVs, significantly increased the detection of SNVs, particularly in regions with highly dense SNVs. By sequentially mapping with BFAST to generate additional reference sequences containing variations, followed by SHRiMP to identify adjacent base mutations within its stringency limitations, followed by iterative remapping by BFAST to convergence (BSBn) gave significant improvement in BCL2, the genetic region showing highest levels of aSHM (FIG. 17B). Here the BSBn approach, compared to single round of BFAST mapping, increased the number of SNVs from 233 to 265 (14% increase) while reducing the number of missed Sanger identified SNVs from 20 to 3 (85% reduction).

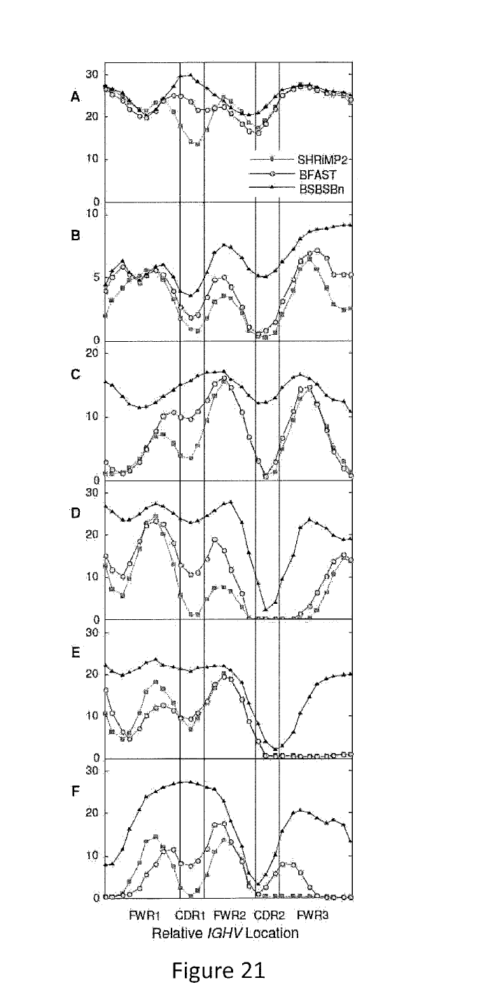

Intraclonal variation within the IGH locus provides a natural experiment to demonstrate the benefits and limitations of DDiMAP. This severe test of the method is accomplished by attempting to map the specimen specific IGH reads to their appropriate IGHV germline sequence (in contrast to use of the mutated clonal IGH reference sequence determined by Sanger sequencing, as in FIG. 14). In essence, what is being tested is the ability of DDiMAP to ‘evolve’ the Sanger level mutations observed IGHV from selected FL specimens. AID-mediated SHM of IGHV is well documented, with most mutations found in the hypervariable complementary determining regions (CDR) of the gene, with relatively fewer in the framework regions (FWR) necessary for protein structure. DDiMAP markedly increased the coverage for all specimens, including for several regions in which mapping with a single round of BFAST or SHRiMP yielded no or limited coverage (FIG. 21E and 21F). The iterative mapping approach using 2 rounds of alternating BFAST and SHRiMP mapping, followed by BFAST to convergence (BSBSBn, n=1-3), identified all the Sanger base calls in specimen 128 with 7.3% IGHV mutation and missed only 2/35 in specimen 127 at 11.9% IGHV mutation (Table S1). All mapping approaches failed to varying degrees as the sequences deviated ≧15% from germline IGHV, with BSBSBn identifying between 40% to 92% of Sanger level base changes while non-iterative mapping identified 29% to 63%. As expected, the best predictor that iteration would increase the detection of a known SNV (identified by Sanger but not identified without iteration) was not the total deviation in sequence, but the pattern of mutation clusters. The lowest BSBSBn recovery of Sanger level IGHV sequence was in specimen 136, identifying only 40% of the Sanger calls in a background of 17.3% IGHV variation, while it recovered 92% of Sanger calls in specimen 132 with an equivalent 17.7% IGHV variation; specimen 136 has 26/48 Sanger identified mutations in adjacent bases (4 doublets and 6 triplets) while specimen 132 has only 14/51 bases changes in adjacent bases (4 doublets and 2 triplets). This effect of mutation clustering is also seen on the mapping coverage observed in the various regions of the IGHV gene, with BSBSBn generating substantial increases in mapping efficiency over the densely mutated CDR 1 and 2 regions (FIG. 21).

### Visualizing Evolution of Diversity

A third advantage to the use of SNV calls within their sequence string context, beyond filtering via cross validation and generating alternate reference fragments for mapping, is the ability to use the variant “word” patterns along with frequency information to form dendrograms that describe the evolution of the tumor subpopulations. Both iteration and use of alternate mapping algorithms bring clarity and enrich the complexity of dendrograms from a region with significant mutations, as seen in a BCL2 region from specimen 128 (FIG. 22). Word analysis based on a single round of BFAST mapping generated a confounded phylogenetic pattern, as incomplete information resulted in an ambiguous evolutionary history for this population, indicated by multiple pathways seeming to lead to the mutation pattern of the most frequent clone. Iteration using BFAST alone to convergence allowed these apparently parallel mutation pathways to coalesce into a single ancestral developmental tree, bringing clarity to the evolutionary pathway. Equally striking is the effect of BSBn, through the recognition of a mutation doublet, identifying a new descendant branch off the founder clone that occurs at a much higher proportion than the other descendants, suggesting either an earlier occurrence or a faster growth rate of this subclone relative to the other descendants off the founder clone.

### Evolutionary Data Reflect Clinically Meaningful Grading of Follicular Lymphoma

Diversity within a tumor can be due to several types of subpopulations, including unrelated divergent populations, remnant “ancestor” populations and more recently evolved populations of “descendants”, relative to the most frequent clone. In contrast to most variant calling algorithms, DDiMAP produces frequencies of each SNV and of each “word”, the combination of SNVs within a 34 bp ROA. In comparing SNV to word frequencies, it is important to note that SNV frequencies aggregate mutations arising at a single location but present in multiple words, obscuring ancestral sub-populations that contain some but not all of the SNVs found in the MFC. The relative contribution of ancestors versus descendants to the intra-clonal diversity can be rapidly assessed from the DDiMAP data as ancestral populations appear only in the diversity phase of cumulative frequency plots based on words while descendants and populations unrelated to MFC are present in the diversity phase of both word and SNV cumulative frequency plots. Final identification of descendants is achieved by SNV per word analysis, as descendants must have one or more additional SNV compared to the MFC while unrelated populations usually have very few SNVs, none of which are present in the MFC.

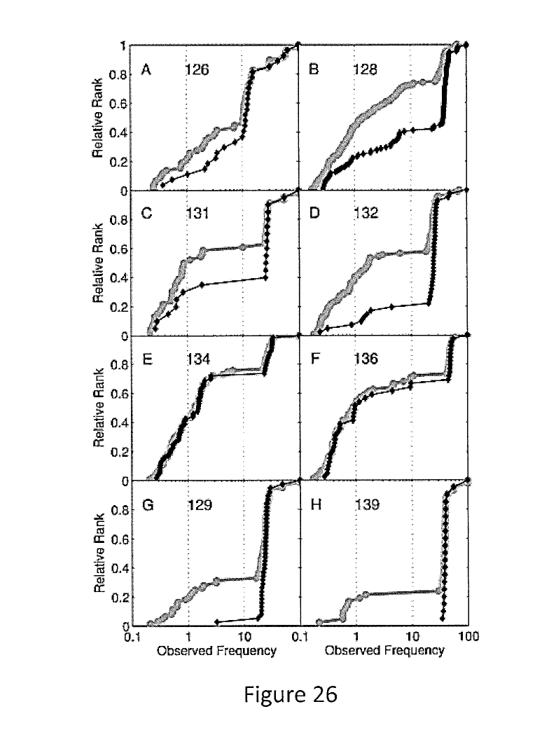

DDiMAP demonstrates that intra-clonal heterogeneity due to small populations well-below the detection of many sequencing methods are common in follicular lymphoma. In all 12 cases evaluated, the cumulative SNV frequency data showed subpopulations with frequencies of 5% or less were present. Of these 12 specimens, 8 had sufficient SNVs densities to construct meaningful cumulative frequency plots (FIG. 26) and in each of these cases the cumulative word frequency plots (gray lines) demonstrated intra-clonal heterogeneity. Additionally, DDiMAP shows that the type of intratumoral diversity varies with tumor grade, a highly relevant clinical parameter which affects therapeutic options. While all specimens show diversity based on cumulative word frequency plots, in 2 specimens (129 and 139) the diversity is due only to ancestors with no detectable descendants; these two specimens are the only two grade 3 tumors in the collection.

### Sensitivity of DDiMAP

In order to assess the sensitivity of the word based analysis method as a function of the underlying variant occurrence rate, an in silico mixing experiment was performed by mixing reads from two specimens at proportions ranging from 1:31 to 31:1. The variants present in the pure specimen data were marked as present/absent at each dilution. A logistic model was fit using the logarithm of the product of the pure sample observed SNV frequency and the dilution factor as a predictor and the presence or absence of the variant as the dependent variable. The resulting model (FIG. 11) indicates that the sensitivity of the analysis method is 80% for SNVs occurring at a frequency of 0.4%, with a >99% probability of identifying variants occurring at 1%.

### Specificity of DDiMAP

Based on Poisson distribution analysis of FL specimens showing aSHM, only 4 (BCL2, BCL6, RHOH and PAX5) of the 8 non-IGH gene regions had differential mutation rates compared to the non-malignant lymphocyte controls (FIG. 19). Making the highly conservative assumption that all the SNVs called in the four remaining non-IGH genes are false positives, indicates a minimum specificity 99.6%. This high specificity is not surprising, considering approximately one-third of the analyzed regions from both FL and controls had no SNV calls (FIG. 19). It can be estimated that an apparent upper bound on the false discovery rate for DDiMAP, based on the following: if one assumes all non-verified SNV calls for the control specimens for all genetic regions (based on Sanger sequencing), as well as all non-verified SNV calls for all FL specimens from the uninformative genes (CD83, PIM1, MYC, SYK) are false positives, a false positive rate of 1.03 SNVs/KB (79 SNVs/76688 bases) can be estimated. Using a similar approach, it can be assumed that all SNV calls in the informative genetic regions from FL specimens (BCL2, BCL6, IGH-enh, RHOH and PAX5) as well as SNV variation around private IGH sequences estimate a combined true positive and false positive rate of 36.36 SNVs/KB (2571 SNVs/70718 bases). Based on these ratios, an upper limit of the false discovery rate was calculated at 2.8%.

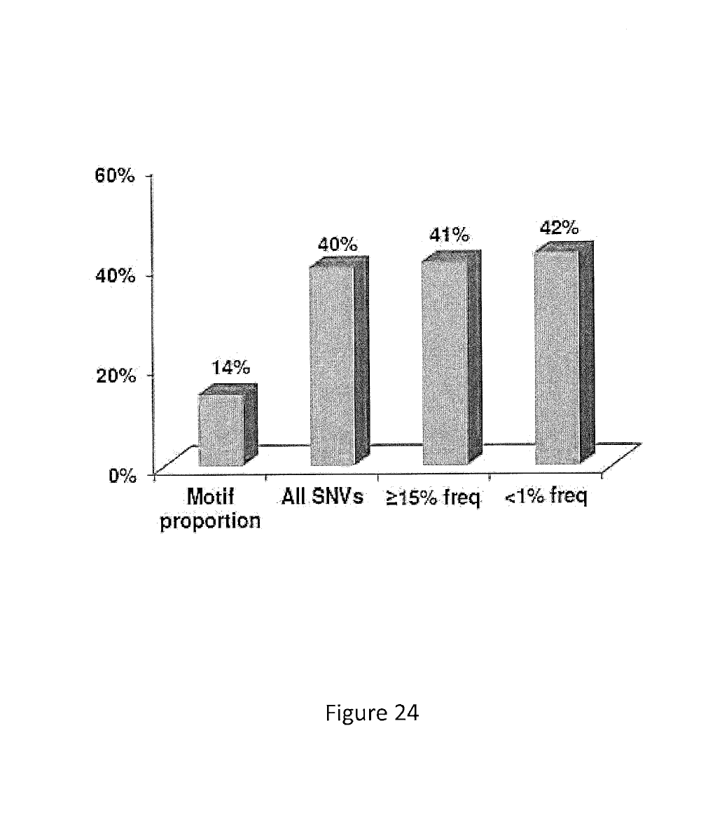

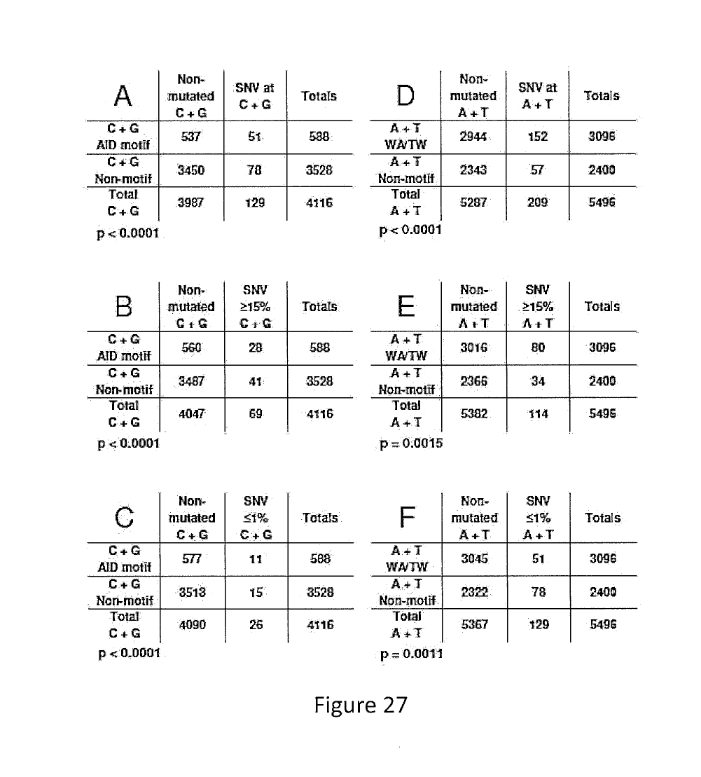

Analysis of the tumor specific SNVs in BCL2 regions from FL specimens, at both high (≧15%) and extremely low (≦1%) allele frequencies identified a consistent and highly significant bias towards the AID mutation patterns (FIG. 24 and FIG. 27, WRCY motif p≦0.0005, WA/TW motif p≦0.0015 by one-tailed Fisher's exact test performed at http://graphpad.com), strongly indicating that the called SNVs at both high and low frequencies are due to aSHM and are not a computational artifact.

DDiMAP was used in this Example to evaluate tumor heterogeneity in follicular lymphoma, a cancer of B-lymphocytes that is well characterized with regard to AID-mediated ongoing somatic hypermutation of IGH. DDiMAP has a measured sensitivity of an 80% probability of observing a 0.4% allele frequency, as determined with logistic modeling of an in silico mixing experiment (FIG. 11) and a maximum of 2.8% false discovery rate for this collection of specimens. Additionally, the consistency of observed AID mutation patterns between high (≧15%) and extremely low (≦1%) allelic frequencies provides strong evidence that low frequency SNV calls represent true variation, not artifact (FIG. 20).

The DDiMAP approach is based on computational units (ROAs) that can be adjusted to accommodate various design parameters. An ROA dictionary analysis is completely determined by 3 parameters: choice of a start position, overlap length, and coverage-dependent frequency threshold. The magnitude and nature of the noise in the nucleotide sequences for each read interacts with the overlap length. If the noise is high and the overlap length is long, too many words will contain noise and will lead to a large coverage loss from the filters. If the overlap length is too short, the effectiveness of the verification procedure is reduced as it involves matching fewer bases. Use of a longer overlap length leads increases the risk of rejecting entire reads that may not fully cover any ROA in a collection. Additionally, these same 3 parameters interact in determining read sequence utilization, as segments of twice the overlap length are selected out of each read and the remaining bases are trimmed and thereby lost to further analysis (FIG. 13). It was found that for reads of length 50 from SOLiD v4, that an overlap length of 17 and ROA size of 34 was most effective, even though it initially reduces the total base coverage as 16 bases are trimmed from each 50 base read (32% loss). Shorter overlap lengths result in even greater initial loss of coverage due to read trimming until overlaps become short enough to accommodate 2 abutting ROAs, reducing the initial coverage loss by using both portions, as in overlaps of 12 with 50 base reads resulting in 4% loss. The strategy of employing analysis results from a second ROA collection with an off-set start position led to further SNV discovery, and effectively cuts the base coverage loss due to trimming by half as it utilizes different portions of each read.

The threshold setting to eliminate the vast majority of process noise was heuristically determined, based on sequencing data from a gel-purified plasmid fragment (pBluescript II KS) which was spiked into FL specimens, and confirmed for suitability in gene samples from non-malignant lymphoid controls and a cell line. Reads from each specimen that mapped to pBluescript II KS were collected and analyzed for using an overlap length of 17 with various settings of the coverage proportional threshold. In this data set, with combined total coverage ˜45000×, even when a high threshold of 5000 ppm was set, four variants were consistently found. When the threshold was reduced below 750 ppm, other variants began to be detected, so 750 ppm was selected as a candidate threshold for effective elimination of false discovery. Targeted genes from FL specimens showed dramatically higher variant occurrence rates in comparison to control specimens, consistent with the presence of true variants expected in these samples.

Applying evolutionary concepts to tumor biology requires detailed phylogenetic mapping with quantification of the subclonal populations. Whole genome sequencing of large numbers of individual cells from a single tumor could produce this type of detailed information. However, this type of approach is not relevant to the archival clinical specimens that are typically available. Kataegis and aSHM, because the mutations are so tightly clustered, provide the opportunity to build phylogenetic trees and thus explore tumor heterogeneity in a quantitative manner using specimens for which it is not possible to obtain single cells. DDiMAP is a quantitative approach that overcomes the two major obstacles to making maximal use of the diversity data in these regions: first, the method sensitively and specifically detects very small populations that are often considered undetectable due to the noise inherent in NGS methods; second, the method is able to capture reads that are highly divergent, representing the extreme evolutionary twigs, that mapping programs often discard. The quantitative nature of the DDiMAP data may allow modeling of the relative rates of growth and mutagenic events and is applicable to the characterization of evolution in clinical specimens.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A method of identifying genetic variants within a population of sequences, comprising:
aligning a set of sequence data reads to reference sequences;
dividing reference sequences into multiple tracks of overlapping regions of analysis (ROAs);
partitioning each read into a ROA;
identifying a plurality of sequence patterns in the reads;
setting a sequence pattern frequency threshold value;
eliminating any sequence pattern that has a value below the frequency threshold value;
forming a plurality of dictionaries from the sequence patterns having a value above the frequency threshold value; and
cross-validating sequence patterns via partial sequence assembly.

2. The method of claim 1, further comprising generating alternate reference alleles from verified sequence patterns that occur above a set frequency to form a custom reference set.

3. The method of claim 2, further comprising iteratively re-aligning the sequence data reads to the custom reference set.

4. The method of claim 1, wherein each ROA is unique.

5. The method of claim 4, wherein the ROAs are in a single track.

6. The method of claim 1, wherein each sequence pattern is unique.

7. The method of claim 1, wherein each sequence pattern is counted with regard to strand and occurrence from each strand.

8. The method of claim 1, wherein the sequence patterns are cross-validated via dictionaries from overlapping ROAs.

9. The method of claim 1, wherein cross-validating sequence patterns via partial sequence assembly generates an additional classification of sequence patterns.

10. The method of claim 9, wherein the additional classification of sequence patterns is verified, ½ verified but kept, non-verified and discarded.

11. The method of claim 1, wherein the sequence pattern frequency threshold value is at least 2 in each sequence direction.

12. A method of characterizing genetic diversity in a population of cells, comprising:
aligning a set of sequence data reads from a cell to reference sequences;
dividing reference sequences into multiple tracks of overlapping regions of analysis (ROAs);
partitioning each read into a ROA;
identifying a plurality of sequence patterns in the reads;
setting a sequence pattern frequency threshold value;
eliminating any sequence pattern that has a value below the frequency threshold value;
forming a plurality of dictionaries from the sequence patterns having a value above the frequency threshold value;
cross-validating sequence patterns via partial sequence assembly, and
determining genetic diversity of the cell based on at least one identified genetic variant.

13. The method of claim 12, wherein the population of cells is a tissue.

14. The method of claim 13, wherein the tissue is a tumor.

15. The method of claim 14, wherein the population of cells comprises tumor subpopulations.

16. The method of claim 15, wherein the tumor subpopulations are determined at least at the 0.4% level.

17. The method of claim 16, wherein the determination has at least an 80% sensitivity for genetic mutations.

18. A system for identifying genetic variants within a population of sequences, comprising:
a software or hosted platform executable on a computing device;
wherein the software or hosted platform is programmed to:
align a set of sequence data reads to reference sequences;
divide reference sequences into multiple tracks of overlapping regions of analysis (ROAs);
partition each read into a ROA;
identify a plurality of sequence patterns in the reads;
set a sequence pattern frequency threshold value;
eliminate any sequence pattern that has a value below the frequency threshold value;
form a plurality of dictionaries from the sequence patterns having a value above the frequency threshold value; and
cross-validate sequence patterns via partial sequence assembly.

19. The system of claim 18, wherein the software or hosted platform is further programmed to generate alternate reference alleles from verified sequence patterns that occur above a set frequency to form a custom reference set.

20. The system of claim 19, wherein the software or hosted platform is further programmed to iteratively re-align the sequence data reads to the custom reference set.

21. The system of claim 18, wherein each ROA is unique.

22. The system of claim 21, wherein the ROAs are in a single track.
